(19) United States
(12) Patent Application Publication
(10) Pub. No.: US 2026/0208527 A1
(43) Pub. Date: Jul. 23, 2026

(54) MOVING BODY AND MOVING METHOD

(71) Applicant: SONY GROUP CORPORATION, Tokyo (JP)

(72) Inventor: Kazuo HONGO, Tokyo (JP)

(21) Appl. No.: 19/138,149

(22) PCT Filed: Dec. 4, 2023
(86) PCT No.: PCT/JP2023/043215

§ 371 Date: Jun. 12, 2025

(30) Foreign Application Priority Data
Dec. 21, 2022 (JP) 2022-204245

(51) Int. Cl. B60B 19/14; B60B 19/00

(52) U.S. Cl. CPC B60B 19/14; B60B 19/003

(57) ABSTRACT

The present technology relates to a moving body and a moving method that improve a traveling performance of the moving body including an omnidirectional wheel. A moving body includes at least one omnidirectional wheel including a rotating body that is rotatable about a first rotation axis, in which the rotating body includes a rotation frame that is rotatable about the first rotation axis and three or more wheel units arranged in a circumferential direction on a side surface of the rotation frame, and the wheel unit includes a first wheel that is rotatable about a second rotation axis orthogonal to the first rotation axis and the side surface of the rotation frame, includes a spherical-zone shaped grounding surface, and has a top portion where an opening portion is formed and a second wheel that is rotatable about a third rotation axis orthogonal to the first rotation axis and the second rotation axis and includes a grounding surface exposed from the opening portion of the first wheel. The present technology is applicable to, for example, a legged robot.

### TECHNICAL FIELD

The present technology relates to a moving body and a moving method and, more particularly, to a moving body and a moving method using an omnidirectional wheel.

### BACKGROUND ART

Conventionally, omni wheels and mecanum wheels are known as omnidirectional wheels. Furthermore, as a spherical omnidirectional wheel that has a high step traveling ability and can move in all directions, an omni ball is known (for example, refer to Patent Document 1).

### CITATION LIST

### Patent Document

Patent Document 1: Japanese Patent Application Laid-Open No. 2007-210576

### SUMMARY OF THE INVENTION

### Problems to be Solved by the Invention

However, an omni ball has a large gap between two hemispheres, which hinders smooth traveling on flatlands and causes vibration.

The present technology has been made in view of such a situation, and an object of the present technology is to improve a traveling performance of a moving body including an omnidirectional wheel.

### Solutions to Problems

A moving body according to a first aspect of the present technology includes at least one omnidirectional wheel including a rotating body that is rotatable about a first rotation axis, in which the rotating body includes a rotation frame that is rotatable about the first rotation axis and three or more wheel units arranged in a circumferential direction on a side surface of the rotation frame, and the wheel unit includes a first wheel that is rotatable about a second rotation axis orthogonal to the first rotation axis and the side surface of the rotation frame, includes a spherical-zone shaped grounding surface, and has a top portion where an opening portion is formed and a second wheel that is rotatable about a third rotation axis orthogonal to the first rotation axis and the second rotation axis and includes a grounding surface exposed from the opening portion of the first wheel.

A moving method according to a second aspect of the present technology, in which an omnidirectional wheel including a rotating body that is rotatable about a first rotation axis, in which the rotating body includes a rotation frame that is rotatable about the first rotation axis and three or more wheel units arranged to surround the first rotation axis, on a side surface of the rotation frame, and the wheel unit includes a first wheel that is rotatable about a second rotation axis orthogonal to the first rotation axis and the side surface of the rotation frame, includes a spherical-zone shaped grounding surface, and has a top portion where an opening portion is formed and a second wheel that is rotatable about a third rotation axis orthogonal to the first rotation axis and the second rotation axis and includes a grounding surface exposed from the opening portion of the first rotation axis, moves by the rotation of the rotating body, the rotation of the first wheel, and the rotation of the second wheel.

In the first aspect of the present technology, the rotating body rotates about the first rotation axis, the first wheel rotates about the second rotation axis orthogonal to the first rotation axis and the side surface of the rotation frame, and the second wheel rotates about the third rotation axis orthogonal to the first rotation axis and the second rotation axis.

In the second aspect of the present technology, the rotating body rotates about the first rotation axis, the first wheel rotates about the second rotation axis orthogonal to the first rotation axis and the side surface of the rotation frame, the second wheel rotates about the third rotation axis orthogonal to the first rotation axis and the second rotation axis, and the omnidirectional wheel moves by the rotation of the rotating body, the rotation of the first wheel, and the rotation of the second wheel.

### BRIEF DESCRIPTION OF DRAWINGS

FIG. 1 is an external view illustrating a first embodiment of a moving body to which the present technology is applied.

FIG. 2 is an external view illustrating the first embodiment of an omnidirectional wheel.

FIG. 3 is a cross-sectional view illustrating the first embodiment of the omnidirectional wheel.

FIG. 4 is an external view of components included in the first embodiment of the omnidirectional wheel.

FIG. 5 is a diagram for explaining a condition example of an outline of the first embodiment of the omnidirectional wheel.

FIG. 6 is a diagram for explaining the condition example of the outline of the first embodiment of the omnidirectional wheel.

FIG. 7 is a diagram for explaining the condition example of the outline of the first embodiment of the omnidirectional wheel.

FIG. 8 is a schematic diagram illustrating a second embodiment of the omnidirectional wheel.

FIG. 9 is a cross-sectional view illustrating the second embodiment of the omnidirectional wheel.

FIG. 10 is a diagram for explaining a condition example of an outline of the second embodiment of the omnidirectional wheel.

FIG. 11 is a diagram for explaining the condition example of the outline of the second embodiment of the omnidirectional wheel.

FIG. 12 is a schematic diagram illustrating a third embodiment of the omnidirectional wheel.

FIG. 13 is a schematic diagram illustrating a fourth embodiment of the omnidirectional wheel.

FIG. 14 is a schematic diagram illustrating a fifth embodiment of the omnidirectional wheel.

FIG. 15 is a schematic diagram illustrating a sixth embodiment of the omnidirectional wheel.

FIG. 16 is an external view illustrating a modification of a spherical-zone shaped wheel.

FIG. 17 is a schematic diagram illustrating a seventh embodiment of the omnidirectional wheel.

FIG. 18 is a schematic diagram illustrating an eighth embodiment of the omnidirectional wheel.

FIG. 19 is a schematic diagram illustrating a ninth embodiment of the omnidirectional wheel.

FIG. 20 is a schematic diagram illustrating a tenth embodiment of the omnidirectional wheel.

FIG. 21 is a bottom view illustrating a second embodiment of the moving body to which the present technology is applied.

FIG. 22 is an external view illustrating a third embodiment of the moving body to which the present technology is applied.

FIG. 23 is a schematic diagram illustrating an eleventh embodiment of the omnidirectional wheel.

FIG. 24 is a schematic diagram illustrating a twelfth embodiment of the omnidirectional wheel.

### MODE FOR CARRYING OUT THE INVENTION

Hereinafter, modes for carrying out the present technology will be described. The description will be given in the following order.
1. First Embodiment
2. Modifications of Omnidirectional Wheel 12
3. Second Embodiment
4. Third Embodiment
5. Application Examples
6. Modification
7. Others

### 1. FIRST EMBODIMENT

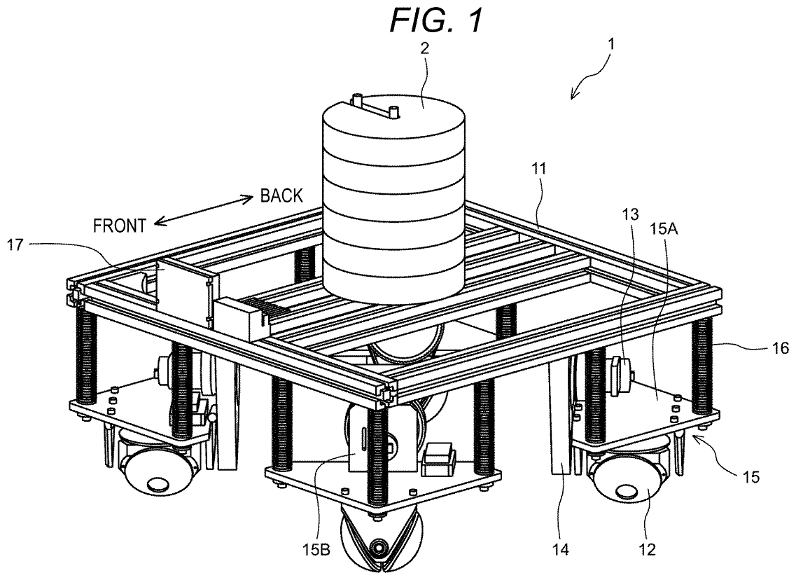

First, a first embodiment of the present technology will be described with reference to FIGS. 1 to 7.

### Configuration Example of Moving Body 1

FIG. 1 illustrates a configuration example of an appearance of a moving body 1 that is the first embodiment of the moving body to which the present technology is applied.

The moving body 1 includes a platform 11, four omnidirectional wheels 12, four motor units 13, four belts 14, four mounting members 15, 12 suspensions 16, and a control unit 17.

Note that, hereinafter, for convenience of description, a front-back direction of the moving body 1 is defined as indicated by an arrow in FIG. 1.

The platform 11 includes a rectangular frame and a plurality of columnar bars connecting between a front side and a rear side of the frame. For example, an interval between the bars of the platform 11 in a horizontal direction can be adjusted in accordance with a size of a cargo 2 or the like.

The mounting member 15 includes a substantially triangular plate-like wheel mounting portion 15A parallel to the platform 11 and a motor mounting portion 15B, perpendicular to the wheel mounting portion 15A, for mounting the motor unit 13. The mounting members 15 are connected to four corners below the platform 11 via the three spring-like suspensions 16.

Each omnidirectional wheel 12 is mounted to a lower surface of the wheel mounting portion 15A of each mounting member 15. Rotation axes of the omnidirectional wheels 12 face different directions by 90 degrees.

The motor unit 13 is mounted to the motor mounting portion 15B of each mounting member 15.

The omnidirectional wheel 12 and the motor unit 13 are connected via the belt 14. The omnidirectional wheel 12 is controlled by the motor unit 13, via the belt 14.

For example, the control unit 17 is realized by a central processing unit (CPU) or the like. The control unit 17 controls a movement (for example, moving speed, moving direction, or the like) of the moving body 1, by controlling each motor unit 13 or the like.

### Configuration Example of Omnidirectional Wheel 12

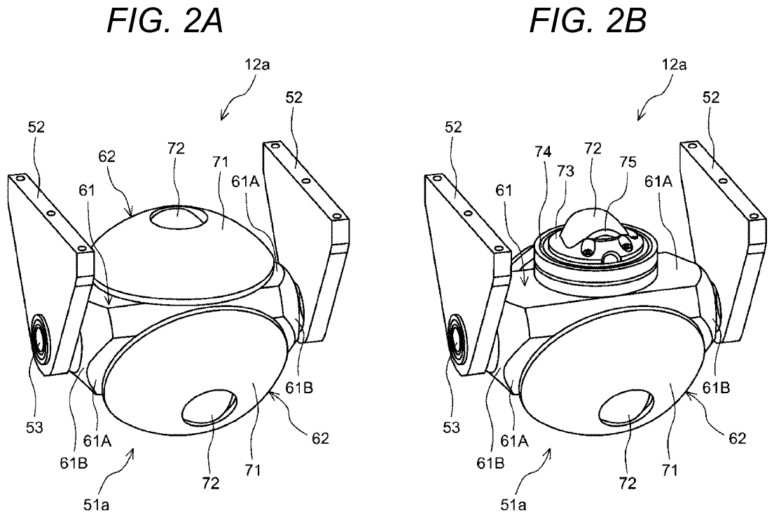

Next, a configuration example of an omnidirectional wheel 12a that is a first embodiment of the omnidirectional wheel 12 of the moving body 1 will be described, with reference to FIGS. 2 to 7.

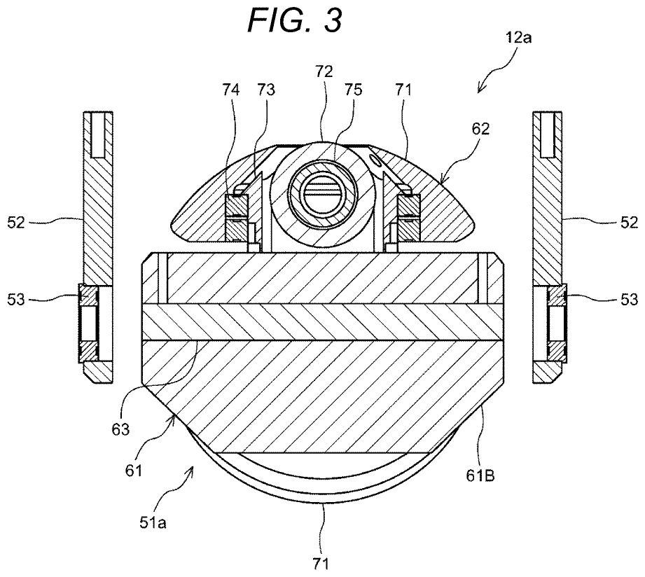

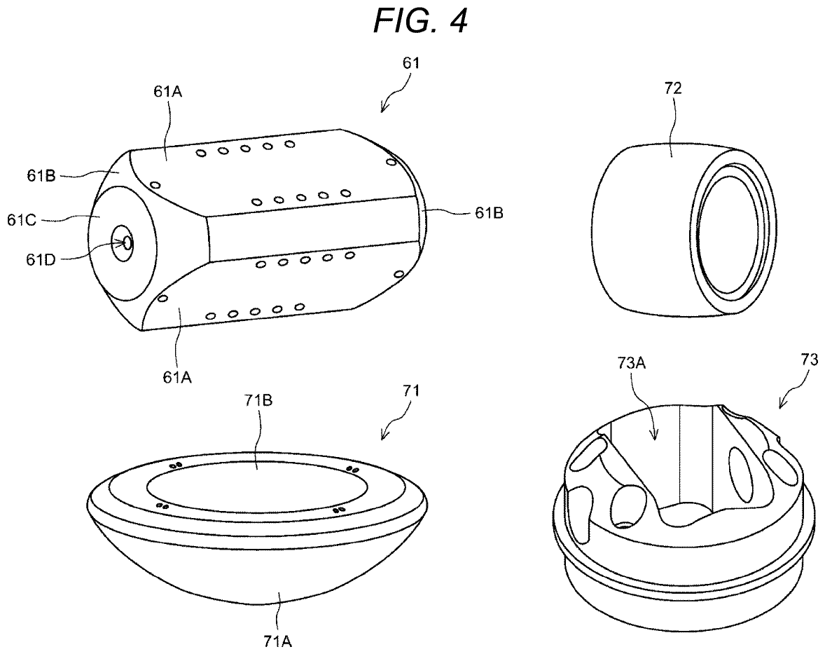

First, a configuration example of an appearance of the omnidirectional wheel 12 will be described, with reference to FIGS. 2 to 4. A of FIG. 2 is a perspective view of the omnidirectional wheel 12a. B of FIG. 2 is a perspective view of the omnidirectional wheel 12 in a state where one spherical-zone shaped wheel 71 is removed. FIG. 3 is a cross-sectional view of the omnidirectional wheel 12a. FIG. 4 is a perspective view of a rotation frame 61, the spherical-zone shaped wheel 71, a small wheel 72, and a support member 73 of the omnidirectional wheel 12a.

The omnidirectional wheel 12a includes a rotating body 51a, two support frames 52, and two bearings 53. The rotating body 51a includes the rotation frame 61, three wheel units 62, and a shaft 63. Each wheel unit 62 includes the spherical-zone shaped wheel 71, the small wheel 72, the support member 73, a bearing 74, and a bearing 75.

Note that, hereinafter, a direction in which the shaft 63 extends is referred to as a horizontal direction or a left-right direction of the omnidirectional wheel 12a. Hereinafter, a direction in which the omnidirectional wheel 12a moves by rotating the shaft 63 is referred to as a front-back direction or a depth direction of the omnidirectional wheel 12a.

The rotation frame 61 is a columnar member. On a side surface of the rotation frame 61, three installation surfaces 61A are formed at equal intervals (intervals of 120 degrees) in a circumferential direction. Both ends of each installation surface 61A on a side of a bottom surface 61C have an arch-like shape. In the circumferential direction of the side surface of the rotation frame 61, an interval is provided between the installation surfaces 61A.

Near the both ends of the side surface of the rotation frame 61, an inclined portion 61B that is inclined in an oblique direction and has a shape close to a truncated cone is formed, and both ends of the rotation frame 61 are tapered. An angle (inclined angle) of an inclined surface of the inclined portion 61B is, for example, set within a range of about 25 degrees to 50 degrees with respect to a rotation axis of the rotating body 51a (shaft 63). Note that an optimum inclined angle of the inclined portion 61B is about 45 degrees. The bottom surface 61C of the rotation frame 61 is circular. A through-hole 61D extending in a direction parallel to the side surface of the rotation frame 61 and passing through the centers of both bottom surfaces 61C of the rotation frame 61 is formed at the middle of the rotation frame 61.

A surface of the rotation frame 61 desirably has a friction coefficient equal to or less than a predetermined threshold (for example, 0.5). For example, a fluororesin is used for the rotation frame 61.

Alternatively, for example, metal such as aluminum-based metal, magnesium-based metal, iron-based metal (including stainless steel), or titanium-based metal, or a resin such as PolyEtherEtherKetone (PEEK) or MC nylon (registered trademark) is used for the rotation frame 61. In this case, for example, in order to reduce friction on the surface of the rotation frame 61, surface treatment such as low friction coating is performed.

The spherical-zone shaped wheel 71 is a spherical-segment-like wheel in which a grounding surface 71A that is a side surface of the spherical-zone shaped wheel 71 and is a surface having contact with the ground at the time of traveling has a spherical-zone shape.

Note that, hereinafter, a surface of the spherical-zone shaped wheel 71 on a side of the rotation frame 61 (hereinafter, referred to as lower surface) is referred to as a lower side or a bottom side of the spherical-zone shaped wheel 71. Hereinafter, a surface of the spherical-zone shaped wheel 71 facing the surface on the side of the rotation frame 61 (hereinafter, referred to as upper surface) is referred to as an upper side or a top side of the spherical-zone shaped wheel 71.

A through-hole 71B that passes through the spherical-zone shaped wheel 71 in a vertical direction is formed in the spherical-zone shaped wheel 71. The through-hole 71B is widened from the top to the bottom, in accordance with an outline of the spherical-zone shaped wheel 71.

The small wheel 72 is a ring-like wheel.

For example, for the spherical-zone shaped wheel 71 and the small wheel 72, a rubber-based material or a resin-based material such as MC nylon (registered trademark) or PolyOxyMethylene (POM) is used.

The support member 73 has a substantially columnar shape and is slightly tapered upward. A through-hole 73A that passes through the support member 73 in the vertical direction is formed at the middle of the support member 73.

The shaft 63 is inserted into the through-hole 61D of the rotation frame 61, and both ends are rotatably supported by the support frames 52 via the bearings 53. The rotation frame 61 is rotatable together with shaft 63, about the shaft 63 as a rotation axis.

Each support member 73 is mounted on each installation surface 61A of the rotation frame 61.

Each spherical-zone shaped wheel 71 is rotatably supported, around the support member 73, about a rotation axis orthogonal to the shaft 63 and the side surface (installation surface 61A) of the rotation frame 61, via the bearing 74. The grounding surface 71A of each spherical-zone shaped wheel 71 forms a part of a common spherical surface (hereinafter, referred to as virtual spherical surface of rotating body 51a or simply referred to as virtual spherical surface). That is, the virtual spherical surface is defined by the grounding surface 71A of each spherical-zone shaped wheel 71. In other words, each grounding surface 71A of each spherical-zone shaped wheel 71 is arranged on the virtual spherical surface.

Note that, hereinafter, a diameter and a radius of the virtual spherical surface are defined as a diameter and a radius of the rotating body 51a. Hereinafter, the diameter and the radius of the virtual spherical surface defined by the grounding surface 71A of each spherical-zone shaped wheel 71 are referred to as a diameter and a radius of the spherical-zone shaped wheel 71 or the grounding surface 71A.

Each small wheel 72 is rotatably supported in the through-hole 73A of the support member 73, about a rotation axis orthogonal to the shaft 63 and a rotation axis of the corresponding spherical-zone shaped wheel 71, via the bearing 75. The grounding surface having contact with the ground at the time of traveling of each small wheel 72 is exposed from an opening portion of a top portion of the spherical-zone shaped wheel 71 (opening portion on upper side of through-hole 71B).

In this way, the rotating body 51a is rotatable about the shaft 63. Each spherical-zone shaped wheel 71 is rotatable about the rotation axis orthogonal to the shaft 63 (rotation axis of rotating body 51a) and the side surface (installation surface 61A) of the rotation frame 61. Each small wheel 72 is rotatable about the rotation axis orthogonal to the shaft 63 (rotation axis of rotating body 51a) and the rotation axis of the spherical-zone shaped wheel 71. Therefore, the rotation axis of the rotating body 51a, the rotation axis of the spherical-zone shaped wheel 71, and the rotation axis of the small wheel 72 are orthogonal to each other.

This improves a traveling performance of the moving body 1 including the omnidirectional wheels 12a.

For example, the omnidirectional wheel 12a is movable in all directions. Specifically, the omnidirectional wheel 12a can be moved in the front-back direction, by rotating the rotating body 51a. Except for a case where the top portion (small wheel 72) that is a singular point of each spherical-zone shaped wheel 71 has contact with the ground, the omnidirectional wheel 12a is movable in all the directions, by rotating each spherical-zone shaped wheel 71. In a case where the top portion (small wheel 72) that is the singular point of each spherical-zone shaped wheel 71 has contact with the ground, the omnidirectional wheel 12a is movable in the left-right direction, by rotating the small wheel 72. Therefore, the moving body 1 is movable in all the directions without turning.

Furthermore, by arranging the three spherical-zone shaped wheels 71 at equal intervals in the circumferential direction on the side surface of the rotation frame 61, a gap between the spherical-zone shaped wheels 71 is reduced. As a result, the omnidirectional wheel 12a can smoothly move, and vibration of the moving body 1 is suppressed.

Moreover, since a grounding area of the omnidirectional wheel 12a is larger than that of a mecanum wheel or an omni wheel, the omnidirectional wheel 12a becomes stronger against impact, and damage to be given on a traveling surface (ground) is reduced.

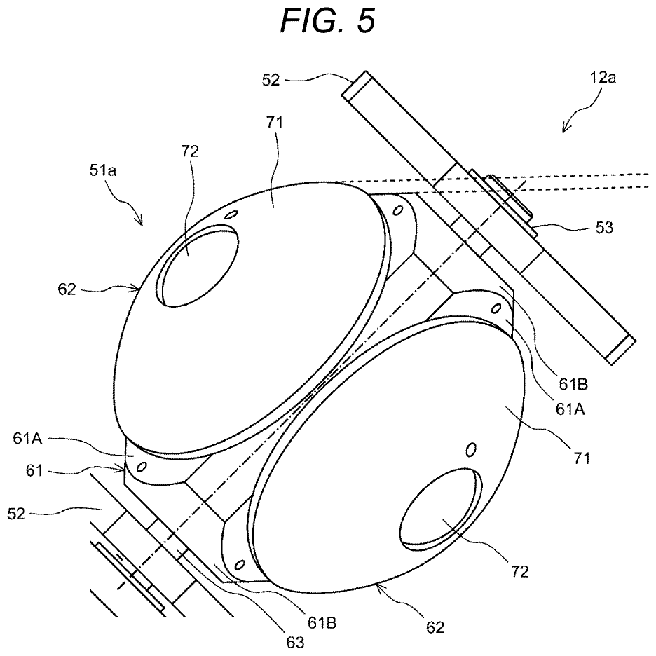

Note that the rotation frame 61 is smaller than the virtual spherical surface of the rotating body 51a. That is, the rotation frame 61 fits within the virtual spherical surface. Therefore, as illustrated in FIG. 5, the inclined portion 61B of the rotation frame 61 is concaved with respect to the spherical-zone shaped wheel 71 (grounding surface 71A thereof). As a result, for example, in a case where the moving body 1 travels across a place having a step (hereinafter, referred to as stepped ground) such as an uneven ground or a staircase, the rotation frame 61 has contact with the step prior to the wheel unit 62 (spherical-zone shaped wheel 71), and a decrease in the traveling performance of the moving body 1 is suppressed. Furthermore, a concave portion of the rotating body 51a (step between spherical-zone shaped wheel 71 and rotation frame 61) is hooked on the step so as to improve a step traveling ability.

However, in a case where the omnidirectional wheel 12a travels across the stepped ground while moving in a direction of the rotation axis of the rotating body 51a, the rotation frame 61 may have contact with the step prior to the wheel unit 62. At this time, as described above, by setting the inclined angle of the inclined portion 61B of the rotation frame 61 to 45 degrees and reducing the friction coefficient of the surface of the rotation frame 61, it is possible to slide the rotation frame 61 with respect to the stepped ground and to smoothly travel across the stepped ground.

Note that, as the inclined angle of the inclined portion 61B of the rotation frame 61 is increased to be larger than 45 degrees, it is more difficult to travel across the stepped ground using the inclined portion 61B, in a case where the omnidirectional wheel 12a moves in the direction of the rotation axis of the rotating body 51a.

On the other hand, if the angle of the inclined portion 61B of the rotation frame 61 falls below 45 degrees and the inclined portion 61B protrudes from the virtual spherical surface of the rotating body 51a, a possibility increases that the inclined portion 61B has contact with the step prior to the wheel unit 62. This lowers the step traveling ability.

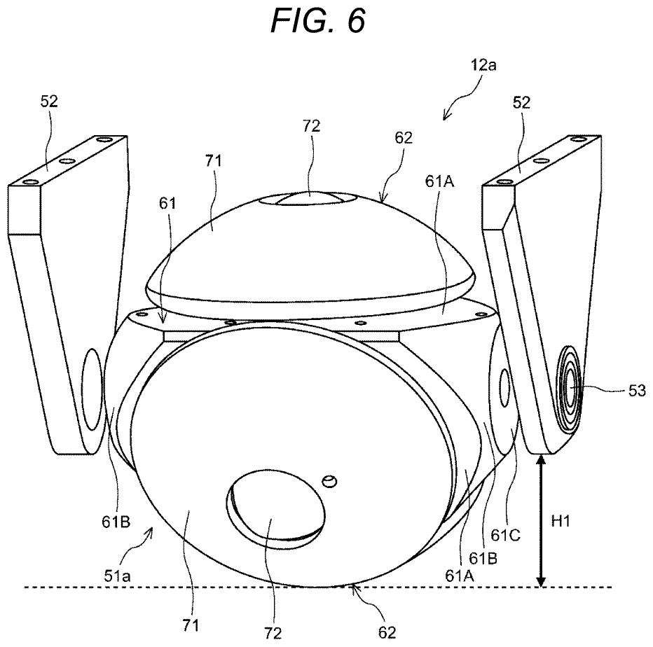

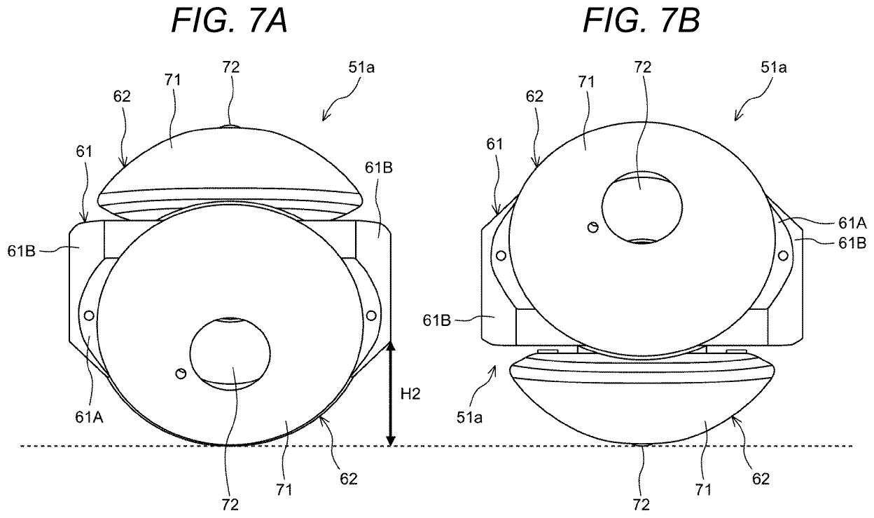

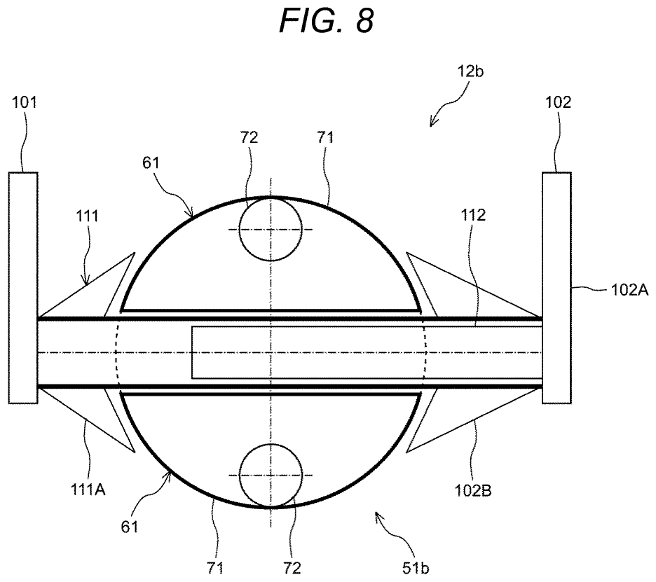

Furthermore, a general wheel can travel over a step having a height of about ⅓ of the diameter, by optimizing friction, a torque, and the like. Therefore, it is desirable that a height H1 of a lower end of the support frame 52 illustrated in FIG. 6 from the ground and a height H2 of a lower end of the end portion (bottom surface) of the rotation frame 61 illustrated in FIG. 7 from the ground be set to be equal to or more than ⅓ of the diameter of the rotating body 51a. This is because there is a possibility that, if the height H1 or the height H2 is less than ⅓ of the diameter of the rotating body 51a, the support frame 52 or the rotation frame 61 has contact with the step and the height of the step where the omnidirectional wheel 12a can travel is limited by the height H1 or the height H2.

<<2. Modifications of Omnidirectional Wheel 12>>Next, modifications of the omnidirectional wheel 12 will be described, with reference to FIGS. 8 to 20.

### Second Embodiment of Omnidirectional Wheel 12

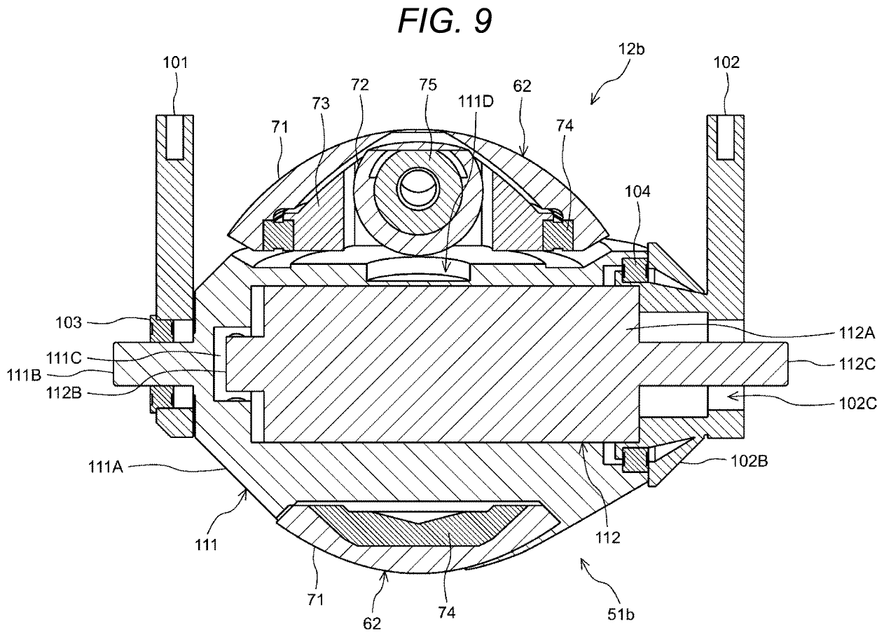

FIGS. 8 and 9 illustrate a configuration example of an omnidirectional wheel 12b that is a second embodiment of the omnidirectional wheel 12. FIG. 8 schematically illustrates a positional relationship of each component of the omnidirectional wheel 12b. Note that, in FIG. 8, for easy understanding of the positional relationship of each component, each wheel unit 62 is illustrated as being arranged at intervals of 180 degrees in the circumferential direction on a side surface of a rotation frame 111. However, the wheel units 62 are actually arranged at intervals of 120 degrees. FIG. 9 is a cross-sectional view specifically illustrating a configuration example of the omnidirectional wheel 12. Furthermore, in FIG. 9, a part corresponding to that of the omnidirectional wheel 12a in FIG. 2 or the like is denoted with the same reference numeral, and description thereof is appropriately omitted.

Note that, hereinafter, for convenience of description, a side viewed in FIG. 9 is referred to as a front side of the omnidirectional wheel 12b, and a left side and a right side in FIG. 9 are respectively referred to as a left side and a right side of the omnidirectional wheel 12b.

The omnidirectional wheel 12b includes a rotating body 51b, a support frame 101, a support frame 102, a bearing 103, and a bearing 104. The rotating body 51b is different from the rotating body 51a of the omnidirectional wheel 12a in that the rotation frame 111 is included instead of the rotation frame 61, a motor unit 112 is added, and the shaft 63 is removed.

In the rotating body 51b, as in the rotating body 51a of the omnidirectional wheel 12a, the three wheel units 62 are arranged along a circumferential direction on a side surface of the rotation frame 111. Therefore, at both ends of the rotation frame 111, a region that is not covered with the wheel unit 62 is formed. By incorporating the motor unit 112 into the rotation frame 111, using this region, the omnidirectional wheel 12b is turned into an in-wheel motor.

Specifically, the rotation frame 111 has the side surface having a shape substantially similar to the rotation frame 61. However, although an inclined portion 111A similar to the inclined portion 61B of the rotation frame 61 is formed near a left end of the rotation frame 111, no inclined portion is formed near a right end of the rotation frame 111. A shaft 111B protrudes from a middle of a left bottom surface of the rotation frame 111. In the rotation frame 111, a housing portion 111C that is a space where the motor unit 112 is inserted and held is formed.

The support frame 101 has a shape similar to the support frame 52 of the omnidirectional wheel 12a.

The support frame 102 includes a frame portion 102A having a shape similar to the support frame 52 of the omnidirectional wheel 12a and a fixed portion 102B formed on a surface on a side of the rotating body 51b of the frame portion 102A. An outline of the fixed portion 102B has a truncated cone shape and is narrowed from the rotating body 51b toward the frame portion 102A. An angle (inclined angle) of a side surface (inclined surface) of the fixed portion 102B with respect to a rotation axis of the rotating body 51b is set to about 45 degrees, similarly to the inclined portion 61B of the rotation frame 61 of the omnidirectional wheel 12a.

The motor unit 112 includes an elongate columnar main body 112A. At a left end (hereinafter, referred to as front end of main body 112A) of the main body 112A in FIG. 9, a protruded shaft 112B is formed. From an end portion (hereinafter, referred to as end of main body 112A) on a right side of the main body 112A in FIG. 9, a cable 112C is extended.

A part of the motor unit 112 is housed in the housing portion 111C of the rotation frame 111. Note that, in order to further miniaturize the omnidirectional wheel 12b, it is desirable that the housing portion 111C be further extended toward the front end side of the rotation frame 111 so that the motor unit 112 can be further inserted to the front end of the rotation frame 111.

The end of the main body 112A of the motor unit 112 is fastened to the fixed portion 102B of the support frame 102 and is fixed so as not to rotate.

The shaft 112B of the motor unit 112 is fastened to the rotation frame 111. The cable 112C of the motor unit 112 is led out from an opening portion 102C of the support frame 102.

The shaft 111B of the rotation frame 111 is rotatably supported by the support frame 101, via the bearing 103. A center of the shaft 111B coincides with a center of the shaft 112B of the motor unit 112.

The bearing 104 is arranged so as to surround the end of the main body 112A of the motor unit 112. The vicinity of an opening portion of the housing portion 111C of the rotation frame 111 is rotatably supported by the fixed portion 102B of the support frame 102, via the bearing 104.

In the motor unit 112, only the shaft 112B is rotatable, and the main body 112A does not rotate. By rotating the shaft 112B, the rotation frame 111 to which the shaft 112B is fastened rotates. As a result, the rotating body 51b is rotatable about the shaft 111B as a rotation axis.

Note that operations of the spherical-zone shaped wheel 71 and the small wheel 72 of each wheel unit 62 are similar to those of the omnidirectional wheel 12a.

In this way, the omnidirectional wheel 12b is turned into an in-wheel motor so that the moving body 1 using the omnidirectional wheel 12b can be miniaturized.

Furthermore, the omnidirectional wheel 12b including a driving unit (motor unit 112 or the like) can be unitized, and the omnidirectional wheel 12b can be easily handled. For example, attachment/detachment of the omnidirectional wheel 12b to/from the moving body 1 is facilitated.

Furthermore, the rotation frame 111 is rotatably supported, at positions sandwiching a center of the rotating body 51b in a rotation axis direction. Specifically, vicinities of both ends of the rotation frame 111 in a rotation axis direction are rotatably supported by the respective bearings 103 and 104. As a result, a load applied to a central portion of the rotating body 51b is appropriately assisted.

Note that, in order suppress deterioration of the motor unit 112, it is desirable that the omnidirectional wheel 12b be dustproof, drip-proof, and waterproof. For example, it is desirable that the bearings 103 and 104 be dustproof, drip-proof, and waterproof. Furthermore, in the rotation frame 111, it is desirable to reduce the number of through-holes communicating with the housing portion 111C from outside, as possible. Moreover, in the fixed portion 102B of the support frame 102, it is desirable to reduce the number of through-holes communicating with the housing portion 111C from the outside, as possible.

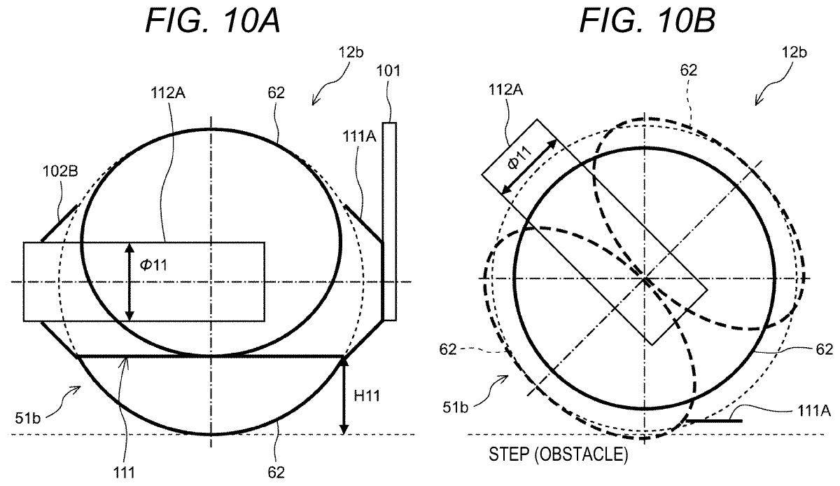

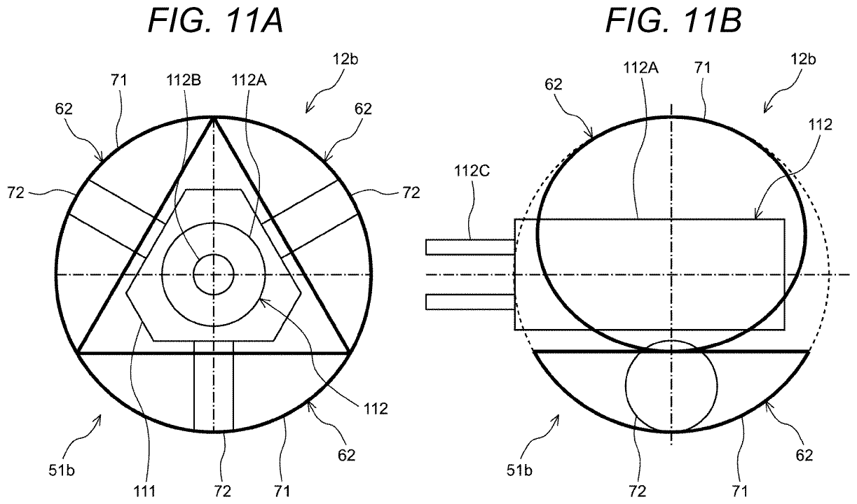

Next, a condition example of an outline of the motor unit 112 will be described, with reference to FIGS. 10 and 11.

A of FIG. 10 schematically illustrates the omnidirectional wheel 12b viewed from an opposite side to FIG. 9. B of FIG. 10 schematically illustrates the omnidirectional wheel 12b viewed from above.

A height H11 of the wheel unit 62 in the rotation axis direction is about ¼ of a diameter of the rotating body 51b. Therefore, in consideration of disassembly and assemblability of the omnidirectional wheel 12b, it is desirable to set a diameter 911 of the main body 112A of the motor unit 112 to be equal to or less than ½ of the diameter of the rotating body 51b.

Furthermore, as described above, a general wheel can travel over a step having a height of about ⅓ of the diameter, by optimizing friction, a torque, and the like.

On the other hand, in a case where the motor unit 112 protrudes to outside of the virtual spherical surface of the rotating body 51b, a diameter q11 of the protruded portion (width in direction perpendicular to rotation axis of rotating body 51b) is desirably set to be equal to or less than ⅓ of the diameter of the rotating body 51b. As a result, a decrease in a step traveling ability of the omnidirectional wheel 12b caused by protruding the motor unit 112 to the outside of the virtual spherical surface of the rotating body 51b is suppressed.

Note that, in addition to the motor unit 112, the same applies to a case where a portion that does not rotate together with the rotating body 51 protrudes from the virtual spherical surface of the rotating body 51b in the rotation axis direction of the rotating body 51b. That is, it is desirable that the width of the protruding portion in the direction perpendicular to the rotation axis of the rotating body 51b be set to be equal to or less than ⅓ of the diameter of the rotating body 51b.

Furthermore, as illustrated in A of FIG. 10, even if the inclined portion 111A of the rotation frame 111 protrudes from the virtual spherical surface of the rotating body 51b, it is suppressed that the omnidirectional wheel 12b hinders a movement of the rotating body 51b in the rotation axis direction. For example, even if the step collides with the inclined portion 111A of the rotation frame 111, the omnidirectional wheel 12b can smoothly run over the step, due to an inclined structure of the inclined portion 111A.

Similarly, as illustrated in A of FIG. 10, even if the fixed portion 102B of the support frame 102 protrudes from the virtual spherical surface of the rotating body 51b, it is suppressed that the omnidirectional wheel 12b hinders the movement of the rotating body 51b in the rotation axis direction. For example, even if the step collides with the fixed portion 102B of the support frame 102, the omnidirectional wheel 12b can smoothly run over the step, due to an inclined structure of the fixed portion 102B.

FIG. 11 schematically illustrates a positional relationship between the small wheel 72 and the motor unit 112 in the rotating body 51b of the omnidirectional wheel 12b. A of FIG. 11 is a schematic diagram of the rotating body 51b viewed from a front end side of the rotation frame 111, and B of FIG. 11 schematically illustrates the rotating body 51b viewed from an opposite side to FIG. 9.

Here, as the small wheel 72 becomes larger, a strength of the small wheel 72 is improved. On the other hand, as the small wheel 72 becomes larger, the small wheel 72 is more likely to physically interfere with the motor unit 112 arranged at the middle of the rotating body 51b.

Therefore, as the main body 112A of the motor unit 112 is miniaturized, that is, the diameter of the main body 112A of the motor unit 112 is shortened, the small wheel 72 can be larger, and the strength can be improved.

Note that, in the omnidirectional wheel 12b in FIG. 9, on the side surface of the rotation frame 111, a groove 111D is formed at a position corresponding to the small wheel 72. As a result, a diameter of the small wheel 72 can be increased. Furthermore, since the groove 111D does not pass through the side surface of the rotation frame 111, decreases in dust-proofness, drip-proofness, and water-proofness of the housing portion 111C are prevented.

Note that each embodiment of the omnidirectional wheel 12 to be described later is applicable to both the in-wheel motor type omnidirectional wheel 12 and the omnidirectional wheel 12 that is not the in-wheel motor type, unless otherwise specified.

### Third Embodiment of Omnidirectional Wheel 12

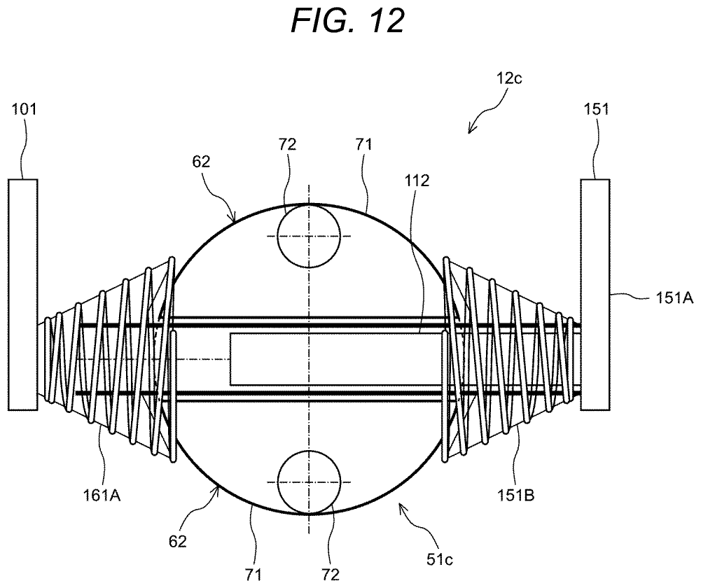

FIG. 12 schematically illustrates a configuration example of an omnidirectional wheel 12c that is a third embodiment of the omnidirectional wheel 12. FIG. 9 schematically illustrates a positional relationship of each component of the omnidirectional wheel 12c. Note that, in FIG. 9, for easy understanding of the positional relationship of each component, each wheel unit 62 is illustrated as being arranged at intervals of 180 degrees in the circumferential direction on a side surface of a rotation frame 161. However, the wheel units 62 are actually arranged at intervals of 120 degrees. Furthermore, in FIG. 9, a part corresponding to that of the omnidirectional wheel 12b in FIG. 8 is denoted with the same reference numeral, and description thereof is appropriately omitted.

The omnidirectional wheel 12c is different from the omnidirectional wheel 12b in that a rotating body 51c and a support frame 151 are provided, instead of the rotating body 51b and the support frame 102. The rotating body 51c is different from the rotating body 51b in that the rotation frame 161 is provided instead of the rotation frame 111.

The support frame 151 includes a frame portion 151A and a fixed portion 151B and has a shape substantially similar to the support frame 102 of the omnidirectional wheel 12b. However, the support frame 151 is different from the support frame 102 in that a surface of a side surface (inclined surface) of the fixed portion 151B has a spiral structure (hereinafter, referred to as spiral structure). This spiral structure is realized, for example, by performing attachment to the fixed portion 151B or processing the fixed portion 151B.

The rotation frame 161 has a shape similar to the rotation frame 111 of the omnidirectional wheel 12b. However, the rotation frame 161 is different from the rotation frame 111 in that a side surface (inclined surface) of an inclined portion 161A has a spiral structure, similarly to the fixed portion 151B of the support frame 151. This spiral structure is realized, for example, by performing attachment to the inclined portion 161A or processing the inclined portion 161A.

For example, in a case where the step is hooked on the fixed portion 151B of the support frame 151 and it is not possible for the omnidirectional wheel 12c to travel across a stepped ground, the spiral structure of the fixed portion 151B rotates so that the omnidirectional wheel 12c easily travels across the stepped ground. Similarly, for example, in a case where the step is hooked on the inclined portion 161A of the rotation frame 161 and it is not possible for the omnidirectional wheel 12c to travel across the stepped ground, the spiral structure of the inclined portion 161A rotates so that the omnidirectional wheel 12c easily travels across the stepped ground.

### Fourth Embodiment of Omnidirectional Wheel 12

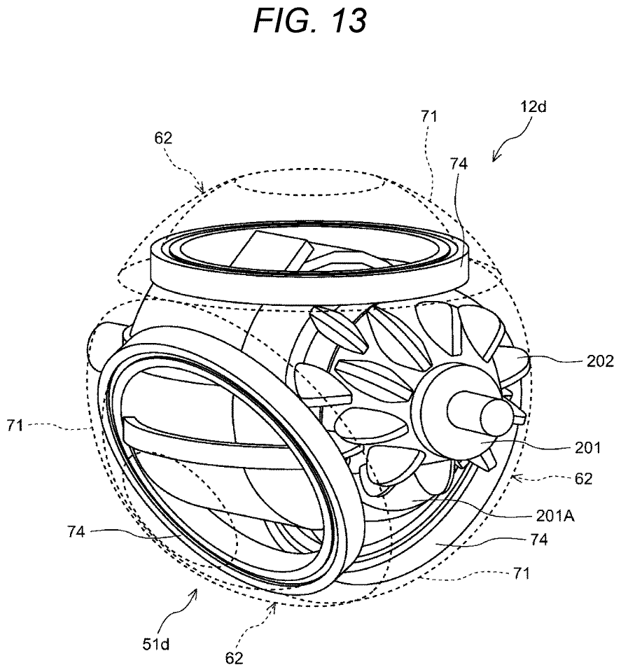

FIG. 13 schematically illustrates a configuration example of an omnidirectional wheel 12d that is a fourth embodiment of the omnidirectional wheel 12. Note that, in FIG. 13, a part corresponding to that of the omnidirectional wheel 12b in FIG. 8 is denoted with the same reference numeral, and description thereof is appropriately omitted.

The omnidirectional wheel 12d is different from the omnidirectional wheel 12b in that a rotating body 51d is included instead of the rotating body 51b. The rotating body 51d is different from the rotating body 51b in that a rotation frame 201 is included instead of the rotation frame 111 and an auxiliary wheel 202 is included.

The plurality of auxiliary wheels 202 is provided on a surface (inclined surface) of an inclined portion 201A of the rotation frame 201. Each auxiliary wheel 202 faces a direction substantially perpendicular to the inclined surface of the inclined portion 201A and can rotate about a rotation axis substantially parallel to the inclined surface of the inclined portion 201A.

As a result, for example, in a case where a step collides with the inclined portion 201A of the rotation frame 201, the omnidirectional wheel 12d can more smoothly travel over the step by using the auxiliary wheel 202 than that in a case where the omnidirectional wheel 12d travels over the step only with a friction force of the rotation frame 201.

### Fifth Embodiment of Omnidirectional Wheel 12

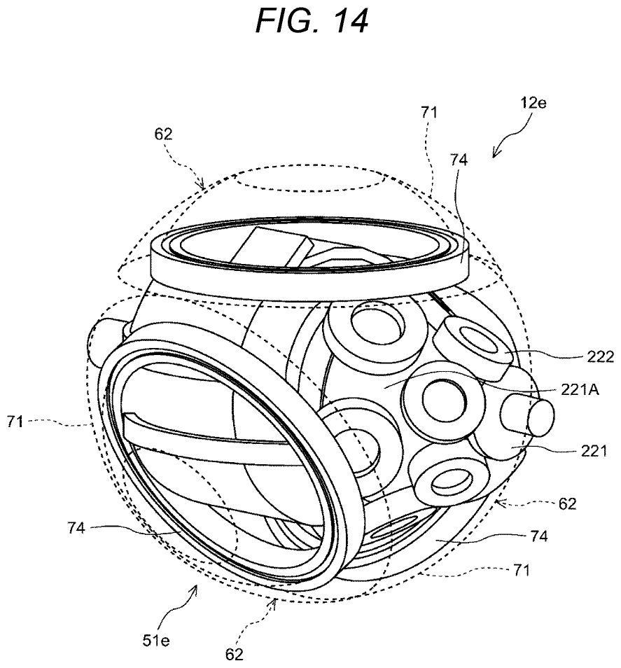

FIG. 14 schematically illustrates a configuration example of an omnidirectional wheel 12e that is a fifth embodiment of the omnidirectional wheel 12. Note that, in FIG. 14, a part corresponding to that of the omnidirectional wheel 12d in FIG. 13 is denoted with the same reference numeral, and description thereof is appropriately omitted.

The omnidirectional wheel 12e is different from the omnidirectional wheel 12d in that a rotating body 51e is included instead of the rotating body 51d. The rotating body 51e is different from the rotating body 51d in that a rotation frame 221 and an auxiliary wheel 222 are included instead of the rotation frame 201 and the auxiliary wheel 202.

On a surface (inclined surface) of an inclined portion 221A of the rotation frame 221, the plurality of auxiliary wheels 222 is provided. Each auxiliary wheel 222 faces a direction substantially perpendicular to the inclined surface of the inclined portion 221A and can rotate about a rotation axis substantially perpendicular to the inclined surface of the inclined portion 221A.

As a result, for example, in a case where a step collides with the inclined portion 221A of the rotation frame 221, the omnidirectional wheel 12e can smoothly travel over the step by using the auxiliary wheel 222 than that in a case where the omnidirectional wheel 12e travels over the step only with a friction force of the rotation frame 221.

### Sixth Embodiment of Omnidirectional Wheel 12

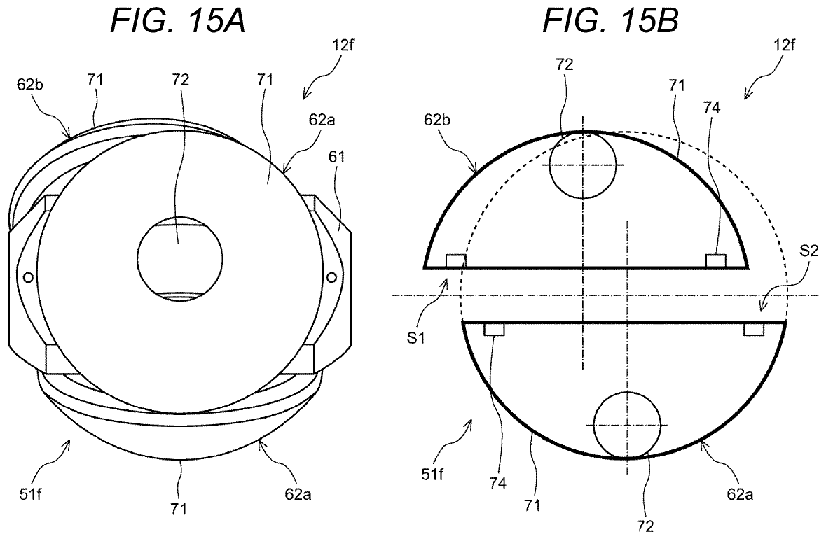

Next, a configuration example of an omnidirectional wheel 12f that is a sixth embodiment of the omnidirectional wheel 12 will be described, with reference to FIG. 15. Note that, in FIG. 15, a part corresponding to that of the omnidirectional wheel 12a in FIG. 2 or the like is denoted with the same reference numeral, and description thereof is appropriately omitted.

A of FIG. 15 illustrates a configuration example of an appearance of a rotating body 51f of the omnidirectional wheel 12f. B of FIG. 15 schematically illustrates a positional relationship of each component of the omnidirectional wheel 12f. Note that, in B of FIG. 15, for easy understanding of the positional relationship of each component, each wheel unit 62 is illustrated as being arranged at intervals of 180 degrees in a circumferential direction on the side surface of the rotation frame 61. However, the wheel units 62 are actually arranged at intervals of 120 degrees.

The omnidirectional wheel 12f is different from the omnidirectional wheel 12a in that the rotating body 51f is provided instead of the rotating body 51a. The rotating body 51f is different from the rotating body 51a in a positional relationship of the wheel units 62.

Specifically, in the rotating body 51f, one wheel unit 62b of the wheel units 62 is deviated from other two wheel units 62a in a direction of a rotation axis (shaft 63 that is not illustrated) of the rotating body 51f. That is, positions of the wheel unit 62a and the wheel unit 62b in a rotation axis direction of the rotating body 51f are different from each other.

As a result, as illustrated in B of FIG. 15, in the rotation axis direction of the rotating body 51f, there is a deviation between a position of a lower surface of a spherical-zone shaped wheel 71 of the wheel unit 62a and a position of a lower surface of a spherical-zone shaped wheel 71 of the wheel unit 62b. As a result, steps S1 and S2 are formed, between the lower surface of the spherical-zone shaped wheel 71 of the wheel unit 62a and the lower surface of the spherical-zone shaped wheel 71 of the wheel unit 62b.

Then, by using the step S1 or S2, a step traveling ability of the omnidirectional wheel 12f is improved. For example, in a case where the omnidirectional wheel 12f travels across the stepped ground, a step is hooked on the step S1 or S2 so that the omnidirectional wheel 12f easily travels across the stepped ground.

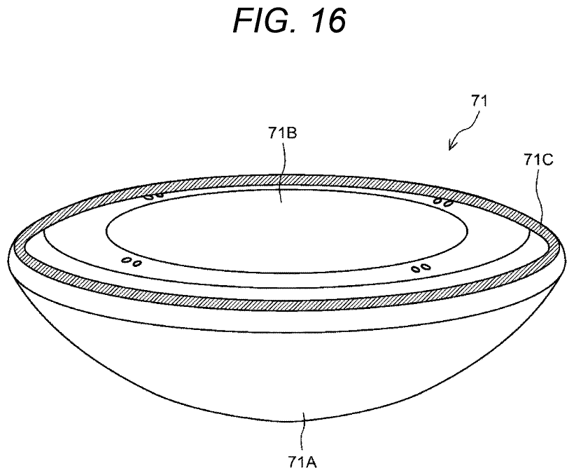

Note that, as illustrated in FIG. 16, it is desirable that a friction coefficient of an outer peripheral portion 71C near an outer periphery of the lower surface of the spherical-zone shaped wheel 71 be set to be larger than an original friction coefficient of a material of the spherical-zone shaped wheel 71. For example, a rubber material is bonded to the outer peripheral portion 71C. For example, a surface of the outer peripheral portion 71C is roughened to be uneven, jagged, or the like.

As a result, for example, in a case where the step S1 or S2 of the rotating body 51f is hooked on the step to be traveled, a portion of the rotating body 51f hooked on the step slides, and drop of the omnidirectional wheel 12f from the step is suppressed. That is, a step traveling ability of the omnidirectional wheel 12f is improved.

Note that, for example, in a case where the step S1 or S2 of the rotating body 51f is hooked on the step to be traveled, in order to prevent a damage or the like of the step, a soft material may be used for an edge portion of the lower surface of the spherical-zone shaped wheel 71.

Furthermore, a method for setting the friction coefficient of the outer peripheral portion 71C of the lower surface of the spherical-zone shaped wheel 71 to be larger than the original friction coefficient of the material of the spherical-zone shaped wheel 71 can be applied to the other embodiments of the omnidirectional wheel 12.

Note that the omnidirectional wheel 12f has a problem to be noted.

For example, when the moving body 1 travels on a flatland, while the rotating body 51f of the omnidirectional wheel 12f rotates about the rotation axis (shaft 63 that is not illustrated) once, a position where the rotating body 51f has contact with the ground (hereinafter, referred to as grounding point) instantaneously moves greatly. That is, a discontinuous movement of a grounding point of the rotating body 51f in the rotation axis direction occurs. As a result, for example, even if a rotation speed of the motor unit 13 is controlled to be constant while the moving body 1 is turning, a turning speed of the moving body 1 changes and becomes unstable, by changing a turning radius of the omnidirectional wheel 12f.

For this, for example, a sensor that can detect at least one of a rotation angle around the rotation axis of the rotating body 51f (encoder for acquiring angle of omnidirectional wheel 12f itself), an angular speed of the moving body 1 (inertial measurement unit (IMU)), or a position and a direction of the moving body 1 (current position and posture estimation using simultaneous localization and mapping (SLAM) by camera or the like) may be installed in the omnidirectional wheel 12f, the motor unit 13, or the like. As a result, for example, the control unit 17 can control the rotation speed of the motor unit 13, in accordance with the rotation angle of the rotating body 51f, when the moving body 1 turns and stabilize the turning speed of the moving body 1.

Specifically, it is assumed that a distance from a turning center of the moving body 1 to a center of the rotating body 51f be R and the grounding point of the rotating body 51f change by ΔR, between the wheel unit 62a and the wheel unit 62b. In this case, with respect to a rotation speed ω0 of the rotating body 51f in a case where the wheel unit 62a is grounded, a rotation speed ω1 of the rotating body 51f in a case where the wheel unit 62b is grounded is represented by the following formula (1).

$$ω1 = R \times ω0 \div ( R + Δ R ) \qquad ( 1 )$$

For example, in order for the control unit 17 to appropriately use this calculation result and stabilize the turning speed of the moving body 1, it is necessary to accurately detect the rotation angle of the rotating body 51f.

For example, the rotation angle of the rotating body 51f can be detected, using an incremental encoder. For example, by registering a relationship between a moment when the rotating body 51f faces directly downward, for example, a moment when a small wheel 72 of the wheel unit 62b of the rotating body 51f is grounded and a Z phase of the incremental encoder and measuring how many times the rotating body 51f rotates as viewed from the Z phase at the time of traveling, an absolute rotation angle of the rotating body 51f is detected.

For example, the rotation angle of the rotating body 51f can be detected, using an absolute encoder or a potentiometer. In this case, the rotation angle of the rotating body 51f can be measured in an entire region.

Furthermore, for example, it is possible to detect a timing when the discontinuous movement of the grounding point of the rotating body 51f occurs (hereinafter, referred to as grounding point moving timing), using the IMU. For example, in a case where a voltage or a current is controlled so that the rotation speed of the motor unit 13 becomes constant, the rotation speed of the rotating body 51f changes at the grounding point moving timing. For example, because the rotation speed of the rotating body 51f changes, the grounding point moving timing can be detected, using an angular speed sensor of the IMU. Then, for example, the control unit 17 controls the motor unit 13, on the basis of a detection result of the grounding point moving timing so as to gradually stabilize the turning speed of the moving body 1.

Moreover, for example, the moving speed of the moving body 1 can be detected by an optical flow, a SLAM technology, or the like, using an external sensor such as a camera, a time of flight (ToF) sensor, or a distance sensor using ultrasonic waves, infrared rays, or the like. Then, the grounding point moving timing can be detected, on the basis of a detection result of the moving speed of the moving body 1. Then, for example, the control unit 17 controls the motor unit 13, on the basis of the detection result of the grounding point moving timing so as to gradually stabilize the turning speed of the moving body 1.

As described above, in a case where the moving body 1 using the omnidirectional wheel 12f performs an operation including a turning component, the rotation speed of the rotating body 51f of the omnidirectional wheel 12f can be controlled so as to maintain a target speed. As a result, the moving body 1 can perform a stable motion without unevenness in the turning speed.

### Seventh Embodiment of Omnidirectional Wheel 12

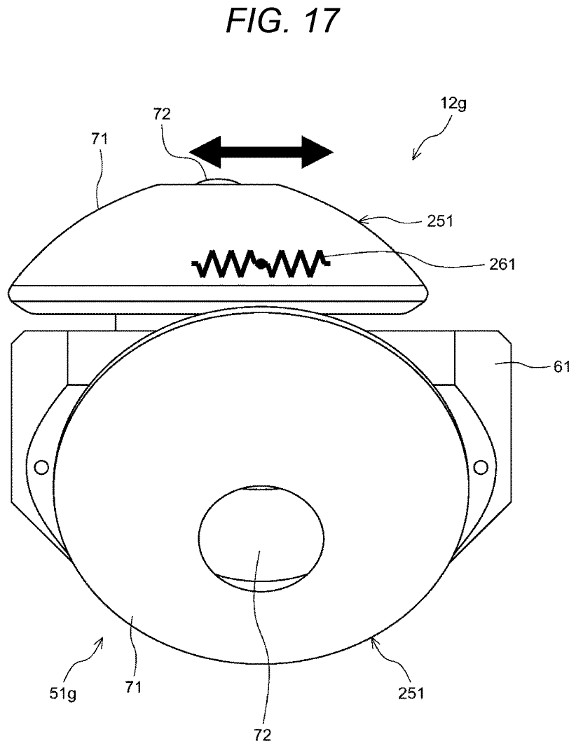

FIG. 17 schematically illustrates a configuration example of an omnidirectional wheel 12g that is a seventh embodiment of the omnidirectional wheel 12. Note that, in FIG. 17, a part corresponding to that of the omnidirectional wheel 12a in FIG. 2 or the like is denoted with the same reference numeral, and description thereof is appropriately omitted.

The omnidirectional wheel 12g is different from the omnidirectional wheel 12a in that a rotating body 51g is included instead of the rotating body 51a. The rotating body 51g is different from the rotating body 51a in that a wheel unit 251 is included instead of the wheel unit 62.

The wheel unit 251 is different from the wheel unit 62 in that a slide mechanism 261 capable of sliding each wheel unit 251 in a direction of a rotation axis (shaft 63 that is not illustrated) of the rotating body 51g is provided. The slide mechanism 261 includes, for example, an elastic body such as a spring.

For example, each wheel unit 251 is normally arranged at a position similar to each wheel unit 62 of the omnidirectional wheel 12a in FIG. 2 (hereinafter, referred to as standard position), by an action of the slide mechanism 261. On the other hand, in a case where a disturbance is applied to the wheel unit 251 due to a collision to a step or the like, the position of the wheel unit 251 slides in a rotation axis direction of the rotating body 51g by the slide mechanism 261. As a result, a step is formed between a lower surface of a spherical-zone shaped wheel 71 of the wheel unit 251 at the standard position and a lower surface of a spherical-zone shaped wheel 71 of the slid wheel unit 251. Then, by using this step, similarly to the omnidirectional wheel 12f described above, the step traveling ability is improved.

Note that, in the omnidirectional wheel 12g, it is possible to make the step between the wheel units 251. Therefore, since the steps may be made at three positions while the rotating body 51g rotates once, the step traveling ability is further improved. For example, the omnidirectional wheel 12g can more quickly travel across the stepped ground.

Furthermore, since there is no step between the wheel units 251 in a normal state, as in the omnidirectional wheel 12f, the occurrence of the discontinuous movement of the grounding point of the rotating body 51g is suppressed.

Note that each wheel unit 251 may be slidable only in one (only left or right) of the rotation axis directions of the rotating body 51g or may be slidable in both of the rotation axis directions of the rotating body 51g (both of left and right directions), with respect to the standard position.

Furthermore, for example, the slide mechanism 261 may be provided only in some of the wheel units 251.

### Eighth Embodiment of Omnidirectional Wheel 12

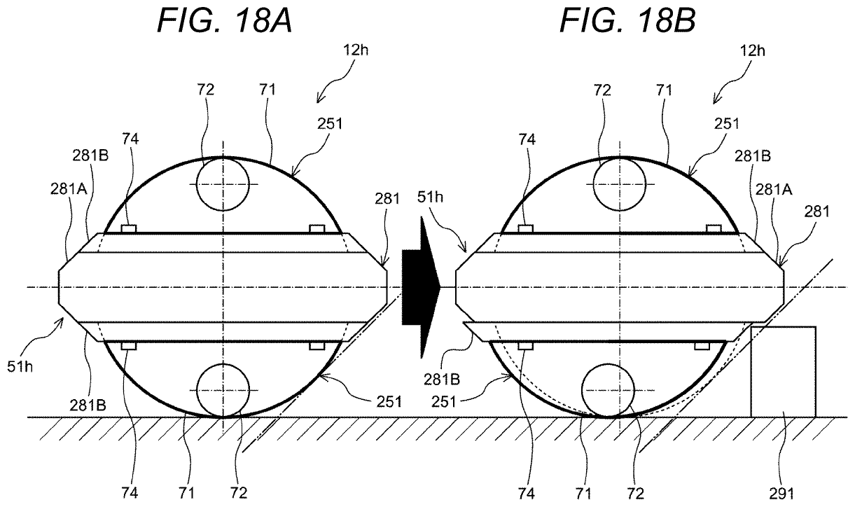

FIG. 18 schematically illustrates a positional relationship of each component of an omnidirectional wheel 12h that is an eighth embodiment of the omnidirectional wheel 12. Note that, in FIG. 18, for easy understanding of the positional relationship of each component, each wheel unit 251 is illustrated as being arranged at intervals of 180 degrees in a circumferential direction on a side surface of a rotation frame 281. However, the wheel units 251 are actually arranged at intervals of 120 degrees. Furthermore, in FIG. 18, a part corresponding to that of the omnidirectional wheel 12g in FIG. 17 is denoted with the same reference numeral, and description thereof is appropriately omitted.

The omnidirectional wheel 12h is different from the omnidirectional wheel 12g in that a rotating body 51h is included instead of the rotating body 51g. The rotating body 51h is different from the rotating body 51g in that the rotation frame 281 is included instead of the rotation frame 61.

The rotation frame 281 is divided into a fixed portion 281A and a slide portion 281B. The slide portions 281B are provided at three positions in correspondence with the wheel units 251. For example, each slide portion 281B is arranged at a position similar to the installation surface 61A of the rotation frame 61 in FIG. 4, and each wheel unit 251 is installed. Then, each slide portion 281B can slide in a rotation axis direction of the rotating body 51h integrally with the installed wheel unit 251. On the other hand, the fixed portion 281A does not slide in the rotation axis direction of the rotating body 51h.

As a result, for example, a degree of freedom in structural design of the omnidirectional wheel 12h is improved. Furthermore, a strength of the bearing 74 of each wheel unit 251 is improved.

Moreover, since a portion where the rotating body 51h slides in the rotation axis direction becomes larger, the step traveling ability is improved. For example, the omnidirectional wheel 12h can travels across a higher stepped ground.

For example, as illustrated in B of FIG. 18, in a case where the omnidirectional wheel 12h moves in the rotation axis direction of the rotating body 51h and travels over a step 291, the slide portion 281B of the rotation frame 281 abuts on the step 291. In this case, if the slide portion 281B does not slide, there is a possibility that traveling over the step 291 by the omnidirectional wheel 12h is hindered by the rotation frame 281.

On the other hand, a step is generated between the fixed portion 281A and the slide portion 281B, by sliding the slide portion 281B in the rotation axis direction of the rotating body 51h. A traveling ability of the omnidirectional wheel 12h with respect to the step 291 is improved, by using this step.

### Ninth Embodiment of Omnidirectional Wheel 12

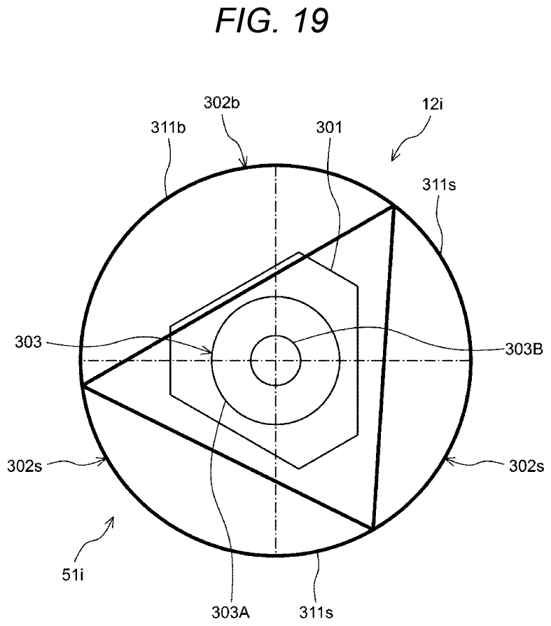

FIG. 19 schematically illustrates a configuration example of an omnidirectional wheel 12i that is a ninth embodiment of the omnidirectional wheel 12.

The omnidirectional wheel 12i includes a rotating body 51i. The rotating body 51i includes a frame 301, a wheel unit 302b, two wheel units 302s, and a motor unit 303. Similarly to the omnidirectional wheel 12b in FIG. 9, the motor unit 303 is inserted into the frame 301.

The omnidirectional wheel 12i is different from the other omnidirectional wheel 12 in that sizes of a spherical-zone shaped wheel 311b of the wheel unit 302b and a spherical-zone shaped wheel 311s of the wheel unit 302s are different.

Specifically, the spherical-zone shaped wheel 311b and the spherical-zone shaped wheel 311s form the same virtual spherical surface. That is, the single virtual spherical surface is defined by a grounding surface of the spherical-zone shaped wheel 311b and a grounding surface of each spherical-zone shaped wheel 311s. Therefore, a diameter of the spherical-zone shaped wheel 311b and a diameter of the spherical-zone shaped wheel 311s have the same length. Furthermore, a diameter of an upper surface of the spherical-zone shaped wheel 311b and a diameter of an upper surface of the spherical-zone shaped wheel 311s have the same length.

On the other hand, a lower surface of the spherical-zone shaped wheel 311b is larger than a lower surface of the spherical-zone shaped wheel 311s. That is, a diameter of the lower surface of the spherical-zone shaped wheel 311b is longer than a diameter of the lower surface of the spherical-zone shaped wheel 311s. Furthermore, the grounding surface (side surface) of the spherical-zone shaped wheel 311b is higher than the grounding surface (side surface) of the spherical-zone shaped wheel 311s. That is, although the grounding surface of the spherical-zone shaped wheel 311b and the grounding surface of the spherical-zone shaped wheel 311s have a shape cut from the same virtual spherical surface, cut widths (height of spherical zone) are different.

Therefore, in a rotation axis direction of the rotating body 51i, the width of the lower surface of the spherical-zone shaped wheel 311b (=diameter of lower surface) is longer than the width of the lower surface of the spherical-zone shaped wheel 311s (=diameter of lower surface). As a result, in the rotation axis direction of the rotating body 51i, a step is formed between the lower surface of the spherical-zone shaped wheel 311b of the wheel unit 302b and the lower surface of the spherical-zone shaped wheel 311s of the wheel unit 302s. For example, the step traveling ability of the omnidirectional wheel 12i is improved, using this step.

Note that, in the omnidirectional wheel 12i, unlike the omnidirectional wheel 12f described above, a discontinuous movement of a grounding point of the rotating body 51i does not occur. Therefore, in the omnidirectional wheel 12i, unlike the omnidirectional wheel 12f, it is not necessary to control a rotation speed on the basis of a rotation angle or the like of the rotating body 51i.

Note that the sizes of the lower surfaces of all the spherical-zone shaped wheels 311 may differ. That is, the lengths of the diameters of the lower surfaces of all the spherical-zone shaped wheels 311 may differ.

### Tenth Embodiment of Omnidirectional Wheel 12

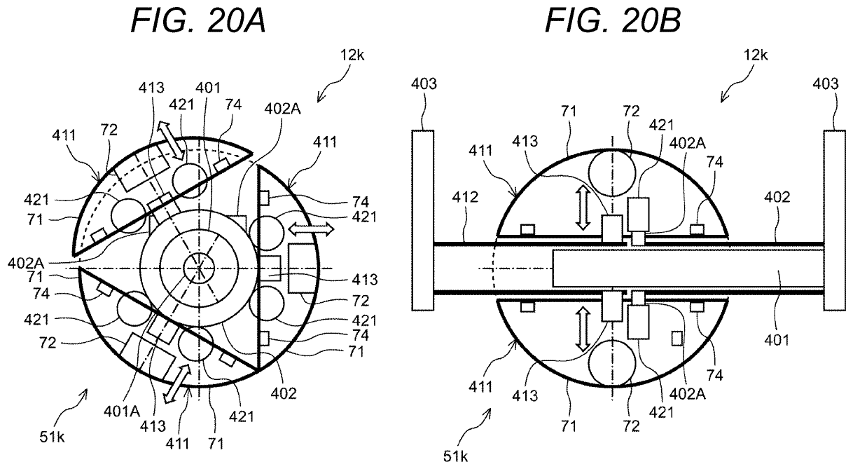

FIG. 20 schematically illustrates a configuration example of an omnidirectional wheel 12k that is a tenth embodiment of the omnidirectional wheel 12. A of FIG. 20 schematically illustrates a positional relationship of each component of the omnidirectional wheel 12k in a case of being viewed from a direction parallel to a rotation axis (shaft 401A of motor unit 401). B of FIG. 20 schematically illustrates a positional relationship of each component of the omnidirectional wheel 12k in a case of being viewed from a direction perpendicular to the rotation axis (shaft 401A of motor unit 401). Note that, in B of FIG. 20, for easy understanding of the positional relationship of each component, each wheel unit 411 is illustrated as being arranged at intervals of 180 degrees in a circumferential direction on a side surface of a rotation frame 412. However, the wheel units 411 are actually arranged at intervals of 120 degrees. Furthermore, in FIG. 20, a part corresponding to that of the omnidirectional wheel 12a in FIG. 2 or the like is denoted with the same reference numeral, and description thereof is appropriately omitted.

The omnidirectional wheel 12k includes a rotating body 51k, the motor unit 401, a cam 402, and two support frames 403. The rotating body 51k includes the three wheel units 411, the rotation frame 412, and three linear motion mechanisms 413. The wheel unit 411 includes two rollers 421, in addition to the components similar to those of the wheel unit 62 in FIG. 3.

The substantially columnar rotation frame 412 is rotatably supported by the left support frame 403 in B of FIG. 20, about the shaft 401A of the motor unit 401. The substantially columnar cam 402 is fixed to the right support frame 403 in B of FIG. 20 and does not rotate. A diameter of the rotation frame 412 and a diameter of the cam 402 are substantially the same length, and the rotation frame 412 and the cam 402 are arranged to be aligned in a rotation axis direction of the rotating body 51k.

Inside of the rotation frame 412 and inside of the cam 402 are hollow, and the motor unit 401 is inserted. The shaft 401A is formed at a front end of the motor unit 401, and the shaft 401A is connected to the rotation frame 412. An end of the motor unit 401 is fixed to the right support frame 403 in B of FIG. 20. In the motor unit 401, only the shaft 401A rotates. At a front end (side of rotation frame 412) of the cam 402, two protrusions 402A are formed in the circumferential direction.

Similarly to the wheel unit 62 of the omnidirectional wheel 12a in FIG. 2 or the like, the wheel units 411 are arranged at equal intervals in the circumferential direction, on a side surface of the rotation frame 412. However, each wheel unit 411 is installed on the side surface of the rotation frame 412, so as to slide in a direction perpendicular to the side surface of the rotation frame 412, via the linear motion mechanism 413.

Near a lower surface of each wheel unit 411, the two rollers 421 are arranged at positions corresponding to the protrusions 402A of the cam 402, at an interval in a direction perpendicular to the rotation axis of the rotating body 51k.

When the shaft 401A of the motor unit 401 rotates, the rotating body 51k rotates about the rotation axis (shaft 401A). At this time, the roller 421 of each wheel unit 411 provided in the rotating body 51k rotates around the rotation axis, about the rotation axis of the rotating body 51k. On the other hand, the cam 402 does not rotate together with the shaft 401A and remains stationary.

Therefore, while the rotating body 51k rotates, a relative position of the roller 421 of each wheel unit 411 with respect to each protrusion 402A of the shaft 401A changes. Then, when the roller 421 abuts on the protrusion 402A of the cam 402, the wheel unit 411 including the roller 421 slides to be separated from the side surface of the rotation frame 412, in a direction perpendicular to the side surface of the rotation frame 412.

As a result, a step is formed between a lower surface of a spherical-zone shaped wheel 71 of the slid wheel unit 411 and a lower surface of a spherical-zone shaped wheel 71 of the adjacent wheel unit 411. A step traveling ability of the omnidirectional wheel 12k is improved, using this step.

Note that the slid wheel unit 411 slides so as to approach the side surface of the rotation frame 412, in the direction perpendicular to the side surface of the rotation frame 412, and returns to an original position, when the roller 421 is separated from the protrusion 402A of the cam 402.

In this way, each wheel unit 411 slides in the direction perpendicular to the side surface of the rotation frame 412, in accordance with a rotation angle of the rotating body 51k.

Note that it is possible for the omnidirectional wheel 12k to make the step between the wheel units 411. Therefore, because the steps are made at three positions while the rotating body 51g rotates once, the step traveling ability is further improved. For example, the omnidirectional wheel 12k can more quickly travel across the stepped ground.

Furthermore, in the omnidirectional wheel 12k, unlike the omnidirectional wheel 12f described above, a discontinuous movement of a grounding point of the rotating body 51i does not occur. Therefore, in the omnidirectional wheel 12k, unlike the omnidirectional wheel 12f, it is not necessary to control a rotation speed on the basis of a rotation angle or the like of the rotating body 51k.

Moreover, for example, in the omnidirectional wheel 12k, each wheel unit 411 may be able to be displaced in the direction perpendicular to the side surface of the rotation frame 412, by a method other than the linear motion mechanism 413.

### 3. SECOND EMBODIMENT

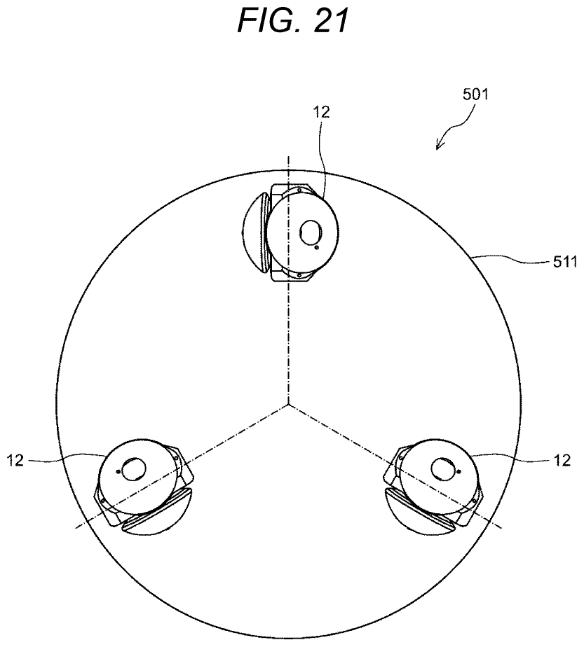

Next, a second embodiment of the present technology will be described with reference to FIG. 21.

FIG. 21 schematically illustrates a bottom view of a moving body 501 to which the present technology is applied.

The moving body 501 includes a circular bottom surface 511. Furthermore, three omnidirectional wheels 12 are arranged at intervals of 120 degrees, along an outer periphery of the bottom surface 511. The omnidirectional wheel 12 may be the omnidirectional wheel 12 in any one of the above embodiments.

Rotation axes of rotating bodies 51 of the respective omnidirectional wheels 12 face directions different from each other. Specifically, the rotation axes of the rotating bodies 51 of the respective omnidirectional wheels 12 face directions different by 120 degrees.

In this way, by including at least three omnidirectional wheels 12 of which the directions of the rotation axes of the rotating bodies are different, the moving body 501 can move in all directions, without falling even in a stationary state.

### 4. THIRD EMBODIMENT

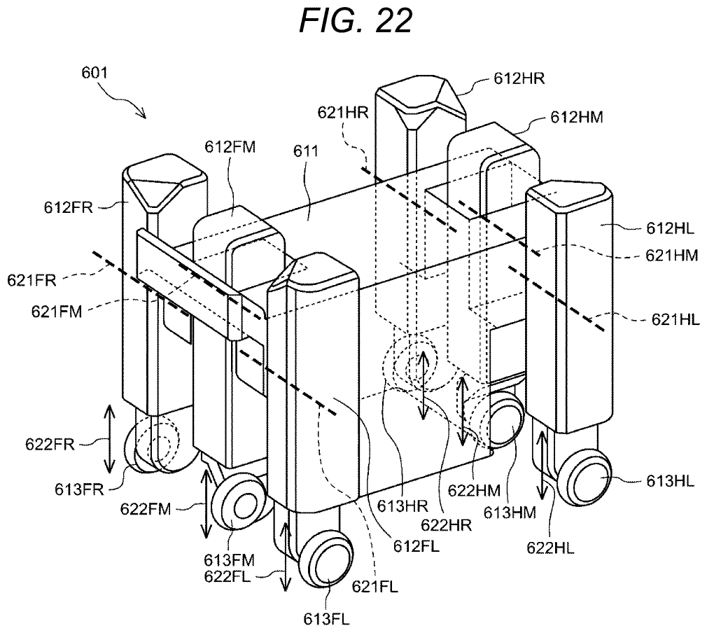

Next, a third embodiment of the present technology will be described, with reference to FIGS. 22 to 24.

An omnidirectional wheel 12 can be applied to, for example, a legged robot including four or more legs. The legged robot is a robot that can move while moving the leg away from the ground or bringing the leg into contact with the ground.

FIG. 22 is a perspective view illustrating a configuration example of an appearance of a moving body 601 that is a legged robot to which the present technology is applied.

The moving body 601 includes a trunk 611, and a left front leg 612FL, a middle front leg 612FM, a right front leg 612FR, a left rear leg 612HL, a middle rear leg 612HM, and a right rear leg 612HR.

The trunk 611 has a shape close to a rectangular parallelepiped. The three front legs including the left front leg 612FL, the middle front leg 612FM, and the right front leg 612FR are arranged to adjacent to each other, on a front side of the trunk 611. The three rear legs including the left rear leg 612HL, the middle rear leg 612HM, and the right rear leg 612HR are arranged to adjacent to each other, on a rear side of the trunk 611.

The left front leg 612FL is rotatably connected to a vicinity of a front end of a left side surface of the trunk 611, in a pitch direction (vertical direction) about a shaft 621FL extending laterally. The left front leg 612FL is stretchable, as indicated by an arrow 622FL. At a front end of the left front leg 612FL, a left front wheel 613FL is provided.

The middle front leg 612FM is rotatably connected to a vicinity of a middle of a front surface of the trunk 611, in the pitch direction about a shaft 621FM extending laterally. The middle front leg 612FM is stretchable, as indicated by an arrow 622FM. At a front end of the middle front leg 612FM, a middle front wheel 613FM is provided.

The right front leg 612FR is rotatably connected to a vicinity of a front end of a right side surface of the trunk 611, in the pitch direction about a shaft 621FR extending laterally. The right front leg 612FR is stretchable, as indicated by an arrow 622FR. At a front end of the right front leg 612FR, a right front wheel 613FR is provided.

The left rear leg 612HL is rotatably connected to a vicinity of a rear end of the left side surface of the trunk 611, in the pitch direction about a shaft 621HL extending laterally. The left rear leg 612HL is stretchable, as indicated by an arrow 622HL. At a front end of the left rear leg 612HL, a left rear wheel 613HL is provided.

The middle rear leg 612HM is rotatably connected to a vicinity of a middle of a rear surface of the trunk 611, in the pitch direction about a shaft 621HM extending laterally. The middle rear leg 612HM is stretchable, as indicated by an arrow 622HM. At a front end of the middle rear leg 612HM, a middle rear wheel 613HM is provided.

The right rear leg 612HR is rotatably connected to a vicinity of a rear end of the right side surface of the trunk 611, in the pitch direction about a shaft 621HR extending laterally. The right rear leg 612HR is stretchable, as indicated by an arrow 622HR. At a front end of the right rear leg 612HR, a right rear wheel 613HR is provided.

Note that, hereinafter, in a case where it is not necessary to distinguish the left front leg 612FL, the middle front leg 612FM, the right front leg 612FR, the left rear leg 612HL, the middle rear leg 612HM, and the right rear leg 612HR from each other, these are simply referred to as a leg 612. Hereinafter, in a case where it is not necessary to distinguish the left front wheel 613FL, the middle front wheel 613FM, the right front wheel 613FR, the left rear wheel 613HL, the middle rear wheel 613HM, and the right rear wheel 613HR from each other, these are simply referred to as a wheel 613.

For example, it is possible to use the omnidirectional wheel 12 in any one of the above embodiments for one or more of the wheels 613. In other words, the omnidirectional wheel 12 can be used for one or more of the legs 612 of the moving body 601. As a result, a turning performance of the moving body 601 is improved.

For example, the omnidirectional wheels 12 are used for the left front wheel 613FL, the right front wheel 613FR, the left rear wheel 613HL, and the right rear wheel 613HR arranged at four corners of the moving body 601. In this case, the middle front wheel 613FM and the middle rear wheel 613HM are not are not necessarily required to be the omnidirectional wheels.

For example, driving wheels that rotate in the pitch direction are used for the left front wheel 613FL, the right front wheel 613FR, the left rear wheel 613HL, and the right rear wheel 613HR arranged at the four corners of the moving body 601, and the omnidirectional wheels 12 are used for the middle front wheel 613FM and the middle rear wheel 613HM.

Note that, in a case where some of the legs 612 of the moving body 601 are separated from the ground and the number of grounding wheels 613 decreases, a spherical-zone shaped wheel of the omnidirectional wheel 12 included in the wheel 613 is a driven wheel. Therefore, there is a possibility that a moving direction of the moving body 601 becomes unstable. On the other hand, it is considered to stabilize the moving direction of the moving body 601, by providing a brake mechanism that acts on the spherical-zone shaped wheel, in the omnidirectional wheel 12.

### Eleventh Embodiment of Omnidirectional Wheel 12

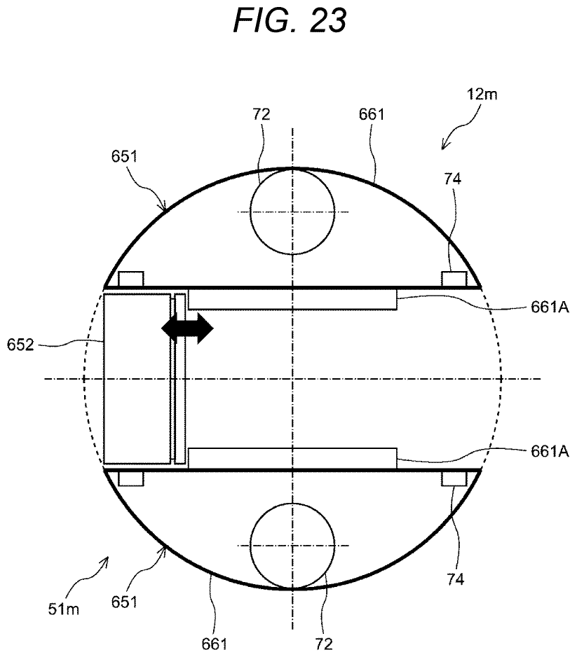

FIG. 23 schematically illustrates a positional relationship of each component of an omnidirectional wheel 12m that is an eleventh embodiment of the omnidirectional wheel 12. Note that, in FIG. 23, for easy understanding of the positional relationship of each component, each wheel unit 651 is illustrated as being arranged at intervals of 180 degrees in a circumferential direction on a side surface of a rotation frame (not illustrated). However, the wheel units 651 are actually arranged at intervals of 120 degrees. Furthermore, in FIG. 23, a part corresponding to that of the omnidirectional wheel 12a in FIG. 2 or the like is denoted with the same reference numeral, and description thereof is appropriately omitted.

The omnidirectional wheel 12m is different from the omnidirectional wheel 12a in that a rotating body 51m is included instead of the rotating body 51a. The rotating body 51m is different from the rotating body 51a in that the wheel unit 651 is included instead of the wheel unit 62 and a brake 652 is added. The wheel unit 651 is different from the wheel unit 62 in that a spherical-zone shaped wheel 661 is included instead of the spherical-zone shaped wheel 71. The spherical-zone shaped wheel 661 is different from the spherical-zone shaped wheel 71 in that a ring-shaped protrusion 661A protruding from a lower surface is formed.

For example, by being slid in an arrow direction (rotation axis direction of rotating body 51m), the brake 652 abuts on a side surface of the protrusion 661A of each spherical-zone shaped wheel 661 or is separated from the side surface of the protrusion 661A of each spherical-zone shaped wheel 661. Then, the brake 652 abuts on the side surface of the protrusion 661A of each spherical-zone shaped wheel 661 so that rotation of each of the spherical-zone shaped wheels 661 stops at one time.

Therefore, by using the omnidirectional wheel 12m for the moving body 601, even if some of the legs 612 are separated from the ground, the moving direction of the moving body 601 is stabilized.

### Twelfth Embodiment of Omnidirectional Wheel 12

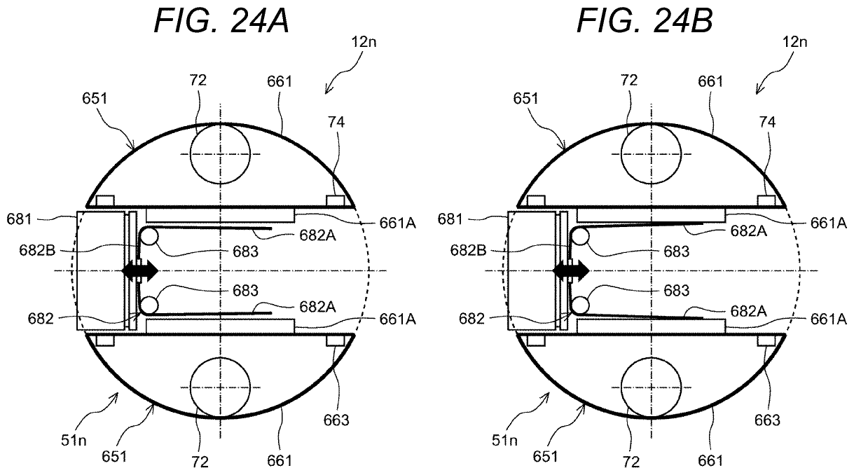

FIG. 24 schematically illustrates a positional relationship of each component of an omnidirectional wheel 12n that is a twelfth embodiment of the omnidirectional wheel 12. Note that, in FIG. 24, for easy understanding of the positional relationship of each component, each wheel unit 651 is illustrated as being arranged at intervals of 180 degrees in a circumferential direction on a side surface of a rotation frame (not illustrated). However, the wheel units 651 are actually arranged at intervals of 120 degrees. Furthermore, in FIG. 24, a part corresponding to that of the omnidirectional wheel 12n in FIG. 23 is denoted with the same reference numeral, and description thereof is appropriately omitted.

The omnidirectional wheel 12n is different from the omnidirectional wheel 12m in that a rotating body 51n is included instead of the rotating body 51m. The rotating body 51n is different from the rotating body 51m in that a brake 681, a U-shaped leaf spring 682, and a roller 683 are included, instead of the brake 681.

Each of two side surfaces 682A of the leaf spring 682 faces a protrusion 661A of each spherical-zone shaped wheel 661. A bottom surface 682B of the leaf spring 682 faces the brake 681. Each corner portion of the leaf spring 682 is supported by the roller 683.

As indicated by an arrow, the brake 681 is slidable in a rotation axis direction of the rotating body 51n (direction perpendicular to bottom surface 682B of leaf spring 682) and can abut on the bottom surface 682B or be separated from the bottom surface 682B.

As illustrated in A of FIG. 24, in a case where the brake 681 is separated from the bottom surface 682B of the leaf spring 682, each side surface 682A of the leaf spring 682 is in a state of being separated from the protrusion 661A of each spherical-zone shaped wheel 661. On the other hand, as illustrated in B of FIG. 24, the brake 681 abuts on the bottom surface 682B of the leaf spring 682 and pushes the bottom surface 682B so as to open a front end of each side surface 682A of the leaf spring 682. As a result, each side surface 682A of the leaf spring 682 abuts on the protrusion 661A of each spherical-zone shaped wheel 661 and, rotation of each spherical-zone shaped wheel 661 stops at one time.

Therefore, by using the omnidirectional wheel 12n for the moving body 601, even if some of the legs 612 are separated from the ground, the moving direction of the moving body 601 is stabilized.

### 5. APPLICATION EXAMPLE

Next, application examples of the omnidirectional wheel 12 will be described.

For example, the omnidirectional wheel 12 is applicable to all moving bodies.

For example, by using the omnidirectional wheel 12, mobility of the moving body is improved. That is, the moving body can move compactly in each direction without turning.

For example, by using the omnidirectional wheel 12, vibration of the moving body is reduced. That is, since vibration of the omnidirectional wheel 12 is small, the vibration of the moving body is reduced. As a result, it is possible to suppress loosening of a screw of the moving body, to improve comfort of a user riding on the moving body, and to suppress damage to an object held or conveyed by the moving body.

For example, by using the omnidirectional wheel 12, a step traveling ability of the moving body becomes higher than that in a case of using a mecanum wheel, an omni wheel, or an omni ball.

For example, since a grounding area of the omnidirectional wheel 12 is larger than that of the mecanum wheel or the omni wheel, the omnidirectional wheel 12 has a higher impact resistance and can reduce a damage given to the traveling surface (ground).

Note that using the in-wheel motor type omnidirectional wheel 12 facilitates installation and wiring on the moving body.

Hereinafter, specific examples of the moving body to which the omnidirectional wheel 12 is applicable will be described.

For example, the omnidirectional wheel 12 is applicable to a four-legged robot that can move in all directions. This improves an impact resistance of the four-legged robot.

For example, the omnidirectional wheel 12 is applicable to a mobile manipulator. For example, since the mobile manipulator holds an object with a hand or mounts a camera, low vibratility of the omnidirectional wheel 12 is effective.

For example, the omnidirectional wheel 12 is applicable to an imaging carriage. For example, in order to suppress camera shake or the like, the low vibratility of the omnidirectional wheel 12 is effective. Since the imaging carriage copes with various imaging scenes, the imaging carriage is desired to be able to move in all the directions. Therefore, the mobility of the omnidirectional wheel 12 is effective. Since it is assumed that the imaging carriage move in a place with a step such as a wiring line or be caught on a falling object from a performer, the step traveling ability of the omnidirectional wheel 12 is effective.

For example, the omnidirectional wheel 12 is applicable to a medical carriage. Since a precision machine is placed on the medical carriage, the low vibratility of the omnidirectional wheel 12 is effective. Since an operating room is narrow and it is assumed that the medical carriage move in various directions depending on a situation, the mobility of the omnidirectional wheel 12 is effective. Since a large number of wiring lines run on the floor of the operating room, the step traveling ability of the omnidirectional wheel 12 is effective.

For example, the omnidirectional wheel 12 is applicable to a harvest robot that harvests and transports crops. For example, in order not to damage the crops, the low vibratility of the omnidirectional wheel 12 is effective. In a narrow field, the mobility of the omnidirectional wheel 12 is effective. In a case where the ground is soil, there is a possibility that the ground may be scraped by the mecanum wheel or the omni wheel. However, the omnidirectional wheel 12 can suppress the scraping.

For example, the omnidirectional wheel 12 is applicable to various vehicles on which a user boards. As a result, comfort of the user and mobility and a step traveling ability of the vehicle are improved. An impact resistance of the vehicle is improved, and the vehicle is less likely to be broken. For example, the omnidirectional wheel 12 is compatible with a golf cart or the like.

For example, the omnidirectional wheel 12 is applicable to an entertainment robot. Since a movement of the entertainment robot is limited when a screw is loosened, the low vibratility of the omnidirectional wheel 12 is effective. Furthermore, by arranging the omnidirectional wheels 12 in three directions as in the moving body 501 in FIG. 21, it is possible to realize cost reduction, weight reduction, and miniaturization of the entertainment robot.

For example, the omnidirectional wheel 12 is applicable to a delivery robot in a warehouse. For example, in order to protect a product being delivered, the low vibratility of the omnidirectional wheel 12 is effective. For example, in a warehouse where narrow passages focusing on a direction change and a process efficiency exist, the mobility of the omnidirectional wheel 12 is effective.

For example, the omnidirectional wheel 12 is applicable to a surveying robot. Since the surveying robot that scans a space is desired to freely move in various directions with low vibration, the low vibratility and the mobility of the omnidirectional wheel 12 are effective.

For example, the omnidirectional wheel 12 is applicable to a sales or delivery robot in a store. For example, in order to protect a product being sold or delivered, the low vibratility of the omnidirectional wheel 12 is effective. For example, the robot can move in the narrow store without turning.

For example, the omnidirectional wheel 12 is applicable to a person and baggage transport robot for rescue or the like. As a result, transmission of vibration to a person being transported is suppressed. Furthermore, the person and baggage transport robot can move in places with various terrains.

For example, the omnidirectional wheel 12 is applicable to a person caring robot. For example, in a case where a person to be cared is guided to walk as holding hands, the person to be cared is likely to feel resistance when vibration is large. Therefore, the low vibratility of the omnidirectional wheel 12 is effective. For example, when the person caring robot falls down by being caught on a wiring line, a falling object, or the like, the person to be cared is in danger. Therefore, the step traveling ability of the omnidirectional wheel 12 is effective.

### 6. MODIFICATIONS

Hereinafter, modifications of the embodiments of the present technology described above will be described.

For example, four or more wheel units may be provided in the omnidirectional wheel 12. That is, the two or more wheel units may be arranged, so as to surround the rotation axis of the rotating body, in the circumferential direction of the side surface of the rotation frame of the omnidirectional wheel. This miniaturizes the spherical-zone shaped wheel included in each wheel unit and makes it easier to rotate. This is particularly effective in a case where the omnidirectional wheel 12 is used for a large moving body such as a vehicle. Furthermore, in a case of an inline-motor-type omnidirectional wheel 12, a size of the motor unit can be increased.

For example, in order to improve a grip performance of the spherical-zone shaped wheel, surface treatment such as forming a groove in the grounding surface of the spherical-zone shaped wheel may be performed.

### 7. OTHERS

Moreover, the embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

### Combination Example of Configuration

The present technology can also have the following configurations.

(1)

A moving body including:
at least one omnidirectional wheel including a rotating body that is rotatable about a first rotation axis, in which
the rotating body includes
a rotation frame that is rotatable about the first rotation axis and
three or more wheel units arranged in a circumferential direction on a side surface of the rotation frame, and
the wheel unit includes
a first wheel that is rotatable about a second rotation axis orthogonal to the first rotation axis and the side surface of the rotation frame, includes a spherical-zone shaped grounding surface, and has a top portion where an opening portion is formed and
a second wheel that is rotatable about a third rotation axis orthogonal to the first rotation axis and the second rotation axis and includes a grounding surface exposed from the opening portion of the first wheel.

(2)

The moving body according to (1), in which
the rotation frame is smaller than a virtual spherical surface defined by the grounding surfaces of at least two of the first wheels.

(3)

The moving body according to (1) or (2), in which
a friction coefficient of a surface of the rotation frame is equal to or less than 0.5.

(4)

The moving body according to any one of (1) to (3), further including:
a motor unit configured to be at least partially housed in the rotation frame and rotate the rotating body about the first rotation axis.

(5)

The moving body according to (4), in which
a width in a direction perpendicular to the first rotation axis of a portion protruding from a virtual spherical surface defined by the grounding surfaces of at least two first wheels in the first rotation axis direction that is a portion that does not rotate together with the rotating body is equal to or less than ⅓ of a diameter of the virtual spherical surface.

(6)

The moving body according to (4) or (5), in which
the rotation frame is rotatably supported at a first position and a second position sandwiching a center of the rotating body in the first rotation axis direction, in the first rotation axis direction.

(7)

The moving body according to any one of (1) to (6), in which
an inclined portion that is inclined so that the rotation frame is tapered is formed, on at least one end portion of the rotation frame in the first rotation axis direction.

(8)

The moving body according to (7), in which
an inclination of the inclined portion with respect to the first rotation axis is within a range of 25 degrees to 50 degrees.

(9)

The moving body according to (7) or (8), in which
a surface of the inclined portion has a spiral structure.

(9)

The moving body according to (7) or (8), in which
a plurality of auxiliary wheels is provided on a surface of the inclined portion.

(10)

The moving body according to any one of (1) to (9), in which
the omnidirectional wheel further includes a brake mechanism that stops rotation of the first wheel of each of the wheel units at one time.

(11)

The moving body according to any one of (1) to (10), in which
a position of at least one of the first wheels in the first rotation axis direction is different from a position of the another first wheel in the first rotation axis direction.

(12)

The moving body according to (11), further including:
a control unit configured to control a rotation speed of the rotating body, on a basis of a rotation angle of the rotating body.

(13)

The moving body according to any one of (1) to (10), in which
a virtual spherical surface is defined by the grounding surface of each first wheel, and
a size of a surface of at least one of the first wheels on a side of the rotation frame is different from a size of a surface of the another first wheel on the side of the rotation frame.

(14)

The moving body according to any one of (1) to (10), in which
at least one of the wheel units is slidable in the first rotation axis direction.

(15)

The moving body according to (14), in which
at least one of the wheel units is slidable in the first rotation axis direction together with a part of the rotation frame.

(16)

The moving body according to any one of (1) to (10), in which
the wheel unit is displaced in a direction perpendicular to the side surface of the rotation frame, in accordance with a rotation angle of the rotating body about the first rotation axis.

(17)

The moving body according to any one of (1) to (16), in which
a friction coefficient near an outer periphery of the first wheel on the side of the rotation frame is larger than an original friction coefficient of a material of the first wheel.

(18)

The moving body according to any one of (1) to (17), further including:
at least the three omnidirectional wheels of which directions of the first rotation axes are different from each other.

(19)

The moving body according to any one of (1) to (18),
further including:
four or more legs, in which
the omnidirectional wheel is included at a front end of at least one of the legs.

(20)

A moving method in which
an omnidirectional wheel including
a rotating body that is rotatable about a first rotation axis, in which
the rotating body includes
a rotation frame that is rotatable about the first rotation axis and
three or more wheel units arranged to surround the first rotation axis, on a side surface of the rotation frame, and
the wheel unit includes
a first wheel that is rotatable about a second rotation axis orthogonal to the first rotation axis and the side surface of the rotation frame, includes a spherical-zone shaped grounding surface, and has a top portion where an opening portion is formed and
a second wheel that is rotatable about a third rotation axis orthogonal to the first rotation axis and the second rotation axis and includes a grounding surface exposed from the opening portion of the first wheel,
moves by the rotation of the rotating body, the rotation of the first wheel, and the rotation of the second wheel.

Note that the effects described herein are merely examples and are not limited, and other effects may be provided.

### REFERENCE SIGNS LIST

1 Moving body
12, 12a to 12i, 12k, 12m, 12n Omnidirectional wheel
13 Motor unit
17 Control unit
51, 51a to 51i, 51k, 51m, 51n Rotating body
61 Rotation frame
61B Inclined portion
62, 62a, 62b Wheel unit
63 Shaft
71 Spherical-zone shaped wheel
71A Grounding surface
71B Through-hole
71C Outer peripheral portion
72 Small wheel
111 Rotation frame
111A Inclined portion
111B Shaft
111C Housing portion
111D Groove
112 Motor unit
112B Shaft
161 Rotation frame
161A Inclined portion
201 Rotation frame
201A Inclined portion
202 Auxiliary wheel
221 Rotation frame
221A Inclined portion
222 Auxiliary wheel
251 Wheel unit
261 Slide mechanism
281 Rotation frame
281A Fixed portion
281B Slide portion
301 Frame
302b, 302s Wheel unit
303 Motor unit
311, 311b, 311s Spherical-zone shaped wheel
331 Frame
332 Motor unit
332B Shaft
401 Motor unit
401A Shaft
402 Cam
402A Protrusion
403 Support frame
411 Wheel unit
412 Rotation frame
413 Linear motion mechanism
501 Moving body
601 Moving body
651 Wheel unit
652 Brake
661 Spherical-zone shaped wheel
661A Protrusion
681 Brake
682 Leaf spring

What is claimed is:

1. A moving body comprising:
at least one omnidirectional wheel including a rotating body that is rotatable about a first rotation axis, wherein
the rotating body includes
a rotation frame that is rotatable about the first rotation axis and
three or more wheel units arranged in a circumferential direction on a side surface of the rotation frame, and
the wheel unit includes
a first wheel that is rotatable about a second rotation axis orthogonal to the first rotation axis and the side surface of the rotation frame, includes a spherical-zone shaped grounding surface, and has a top portion where an opening portion is formed and
a second wheel that is rotatable about a third rotation axis orthogonal to the first rotation axis and the second rotation axis and includes a grounding surface exposed from the opening portion of the first wheel.

2. The moving body according to claim 1, wherein
the rotation frame is smaller than a virtual spherical surface defined by the grounding surfaces of at least two of the first wheels.

3. The moving body according to claim 1, wherein
a friction coefficient of a surface of the rotation frame is equal to or less than 0.5.

4. The moving body according to claim 1, further comprising:
a motor unit configured to be at least partially housed in the rotation frame and rotate the rotating body about the first rotation axis.

5. The moving body according to claim 4, wherein
a width in a direction perpendicular to the first rotation axis of a portion protruding from a virtual spherical surface defined by the grounding surfaces of at least two first wheels in the first rotation axis direction that is a portion that does not rotate together with the rotating body is equal to or less than ⅓ of a diameter of the virtual spherical surface.

6. The moving body according to claim 4, wherein
the rotation frame is rotatably supported at a first position and a second position sandwiching a center of the rotating body in the first rotation axis direction, in the first rotation axis direction.

7. The moving body according to claim 1, wherein
an inclined portion that is inclined so that the rotation frame is tapered is formed, on at least one end portion of the rotation frame in the first rotation axis direction.

8. The moving body according to claim 7, wherein
an inclination of the inclined portion with respect to the first rotation axis is within a range of 25 degrees to 50 degrees.

9. The moving body according to claim 7, wherein
a plurality of auxiliary wheels is provided on a surface of the inclined portion.

10. The moving body according to claim 1, wherein
the omnidirectional wheel further includes a brake mechanism that stops rotation of the first wheel of each of the wheel units at one time.

11. The moving body according to claim 1, wherein
a position of at least one of the first wheels in the first rotation axis direction is different from a position of the another first wheel in the first rotation axis direction.

12. The moving body according to claim 11, further comprising:
a control unit configured to control a rotation speed of the rotating body, on a basis of a rotation angle of the rotating body.

13. The moving body according to claim 1, wherein
a virtual spherical surface is defined by the grounding surface of each first wheel, and
a size of a surface of at least one of the first wheels on a side of the rotation frame is different from a size of a surface of the another first wheel on the side of the rotation frame.

14. The moving body according to claim 1, wherein
at least one of the wheel units is slidable in the first rotation axis direction.

15. The moving body according to claim 14, wherein
at least one of the wheel units is slidable in the first rotation axis direction together with a part of the rotation frame.

16. The moving body according to claim 1, wherein
the wheel unit is displaced in a direction perpendicular to the side surface of the rotation frame, in accordance with a rotation angle of the rotating body about the first rotation axis.

17. The moving body according to claim 1, wherein
a friction coefficient near an outer periphery of the first wheel on the side of the rotation frame is larger than an original friction coefficient of a material of the first wheel.

18. The moving body according to claim 1, further comprising:
at least the three omnidirectional wheels of which directions of the first rotation axes are different from each other.

19. The moving body according to claim 1,
further comprising:
four or more legs, wherein
the omnidirectional wheel is included at a front end of at least one of the legs.

20. A moving method wherein
an omnidirectional wheel including
a rotating body that is rotatable about a first rotation axis, in which
the rotating body includes
a rotation frame that is rotatable about the first rotation axis and
three or more wheel units arranged to surround the first rotation axis, on a side surface of the rotation frame, and
the wheel unit includes
a first wheel that is rotatable about a second rotation axis orthogonal to the first rotation axis and the side surface of the rotation frame, includes a spherical-zone shaped grounding surface, and has a top portion where an opening portion is formed and
a second wheel that is rotatable about a third rotation axis orthogonal to the first rotation axis and the second rotation axis and includes a grounding surface exposed from the opening portion of the first wheel,
moves by the rotation of the rotating body, the rotation of the first wheel, and the rotation of the second wheel.
